(19) United States
(12) Patent Application Publication
(10) Pub. No.: US 2026/0027397 A1
(43) Pub. Date: Jan. 29, 2026

(54) METHODS AND SYSTEMS FOR EXTINGUISHING FIRES

(71) Applicant: Team Wildfire Inc., Longmont, CO (US)

(72) Inventor: Stephen Wolf, Longmont, CO (US)

(73) Assignee: Team Wildfire Inc., Longmont, CO (US)

(21) Appl. No.: 19/347,456

(22) Filed: Oct. 1, 2025

Related U.S. Application Data
(63) Continuation-in-part of application No. 18/561,972.
(63) Continuation-in-part of application No. 18/630,213, filed on Apr. 9, 2024.
(60) Provisional application No. 63/189,463, filed on May 17, 2021.
(60) Provisional application No. 63/851,975, filed on Jul. 28, 2025.
(60) Provisional application No. 63/853,512, filed on Jul. 29, 2025.

(51) Int. Cl. A62C 31/00; A62C 3/02; A62C 27/00

(52) U.S. Cl. CPC A62C 31/005; A62C 3/0292; A62C 27/00

(57) ABSTRACT

A fire suppression system includes fluid storage vessels, pumps fluidically coupled to the vessels, and nozzles that receive and disperse fluids from the pumps. The system utilizes a jet engine configured to disperse the fluids projected from the nozzles, extending their range and improving distribution. All components are supported by a platform configured for mounting on a mobile chassis, enabling deployment on various vehicles including fire trucks, logging trucks, emergency vehicles, and all-terrain vehicles. The system provides enhanced fire suppression capabilities through the integration of high-velocity jet airflow with traditional fluid delivery methods, allowing for extended range and improved effectiveness in challenging firefighting environments.

### CROSS-REFERENCE TO RELATED APPLICATIONS

This application is a continuation-in-part of U.S. application Ser. No. 18/561,972, filed on Nov. 17, 2023, which is a national phase of PCT/US2022/029454, filed on May 16, 2022, which claims the benefit of U.S. Provisional Application No. 63/189,463, filed on May 17, 2021. This application is also a continuation-in-part of U.S. application Ser. No. 18/630,213, filed on Apr. 9, 2024. This application also claims the benefit of U.S. Provisional Application No. 63/851,975, filed on Jul. 28, 2025, and U.S. Provisional Application No. 63/853,512, filed on Jul. 29, 2025. The content of all of these applications is hereby incorporated by reference in its entirety herein.

### BACKGROUND

Wildfires burn millions of acres each year, destroying billions of dollars in homes, businesses, and other assets. Massive fires often overwhelm conventional firefighting resources. Terrain, weather, and limited access routes hinder traditional equipment.

Existing approaches, such as aerial retardant drops, are costly, weather-dependent, and imprecise, while ground crews face fatigue and significant safety risks. Moreover, traditional fire suppression systems that use direct water injection consume enormous quantities of water with limited efficiency. For example, conventional nozzle-based systems may consume upwards of 1,500 gallons of water per minute, resulting in the rapid depletion of both onboard and local water supplies. This limits operational range and duration, particularly in remote or rugged environments where water resupply is difficult or delayed.

### SUMMARY

In a first aspect, a fire suppression system comprises one or more fluid storage vessels; one or more pumps fluidically coupled to the one or more fluid storage vessels; one or more nozzles fluidically coupled to receive one or more fluids from the one or more pumps; a jet engine configured to disperse the one or more fluids dispersed from the one or more nozzles; and a platform configured to support the one or more fluid storage vessels, the one or more pumps, the one or more nozzles, and the jet engine. The platform is configured to be mounted on a mobile chassis or, in some embodiments, to operate from a fixed platform.

In a second aspect, a fire suppression vehicle comprises one or more fluid storage vessels mounted on a chassis of the vehicle; one or more pumps mounted on a chassis of the vehicle and fluidically coupled to the one or more fluid storage vessels, one or more nozzles fluidically coupled to receive one or more fluids from the one or more pumps; a jet engine mounted on a chassis of the vehicle and configured to disperse the one or more fluids dispersed from the one or more nozzles; and a controller configured to control vehicle movement and fire suppression operations. The controller is configured to receive instructions that cause the vehicle to drive to one or more locations and deploy the fire suppression system.

### BRIEF DESCRIPTION OF THE DRAWINGS

The accompanying drawings are included to provide a further understanding of the claims, are incorporated in, and constitute a part of this specification. The detailed description and illustrated examples serve to explain the principles defined by the claims.

FIG. 1 illustrates a schematic of an example fluid projecting system 100, in accordance with some examples.

FIG. 2A illustrates components of a fluid projecting system mounted to a platform, in accordance with some examples.

FIG. 2B illustrates components of a fluid projecting system mounted to a support structure, in accordance with some examples.

FIG. 3 illustrates an example vehicle 300 that comprises an example integrated fluid projecting system 100, in accordance with some examples.

FIG. 4A illustrates a top view of an ultrasonic humidification system, in accordance with some examples.

FIG. 4B illustrates a side view of an ultrasonic humidification system, in accordance with some examples.

FIG. 5 illustrates an ultrasonic humidification system on a vehicle, in accordance with some examples.

FIG. 6A illustrates a network diagram of a system for an AI-based automated real-time allocation of wildfire management and suppression resources and assets based on predictive analytics of wildfire-related data, in accordance with some examples.

FIG. 6B illustrates a network diagram of a system for an AI-based automated real-time allocation of wildfire management and suppression resources and assets based on predictive analytics of wildfire-related data implemented over a blockchain, in accordance with some examples.

FIG. 7 illustrates a network diagram of a system including detailed features of a fire analysis server (FAS) node, in accordance with some examples.

FIG. 8A illustrates a flowchart of a method for an AI-based automated real-time allocation of wildfire management and suppression resources based on predictive analytics of wildfire-related data, in accordance with some examples.

FIG. 8B illustrates a further flowchart of a method for AI-based automated real-time allocation of wildfire management and suppression resources based on predictive analytics of wildfire-related data consistent with the present disclosure.

FIG. 9 illustrates deployment of a machine learning model for prediction of asset allocation-related parameters using blockchain assets consistent with the present disclosure.

FIG. 10 illustrates a computer system that can form part of or implement computational aspects of any of the systems and/or devices described above, in accordance with some examples.

### DETAILED DESCRIPTION

Various examples of devices and/or methods are described herein. Words such as “example” that may be used herein are understood to mean “serving as an example, instance, or illustration.” Any embodiment, implementation, and/or feature described herein as being an “example” is not necessarily to be construed as preferred or advantageous over any other embodiment, implementation, and/or feature unless stated as such. Thus, other embodiments, implementations, and/or features may be utilized, and other changes may be made without departing from the scope of the subject matter presented herein.

Accordingly, the examples described herein are not meant to be limiting. It will be readily understood that the aspects of the present disclosure, as generally described herein and illustrated in the figures, can be arranged, substituted, combined, separated, and designed in a wide variety of different configurations.

Further, unless the context suggests otherwise, the features illustrated in each of the figures may be used in combination with one another. Thus, the figures should be generally viewed as component aspects of one or more overall embodiments, with the understanding that not all illustrated features are necessary for each embodiment.

Moreover, terms such as “substantially” or “about,” that may be used herein, mean that the recited characteristic, parameter, or value need not be achieved exactly, but that deviations or variations, including, for example, tolerances, measurement error, measurement accuracy limitations, and other factors known to those skilled in the art, may occur in amounts that do not preclude the effect the characteristic was intended to provide.

Unless otherwise defined, all technical terms used herein have the same meaning as commonly understood by one of ordinary skill in the art to which this disclosure belongs.

As used herein, the singular forms “a,” “an,” and “the” include plural references unless the context clearly dictates otherwise. Any reference to “or” herein is intended to encompass “and/or” unless otherwise stated. The term “about” in some cases refers to an amount that is approximately the stated amount. For example, an amount that is greater or less than the stated amount or percentage by 10%, 5%, or 1%, including increments therein. The phrases “at least one,” “one or more,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” and “A, B, and/or C” means A alone, B alone, C alone, A and B together, A and C together, B and C together, or A, B, and C together.

### Introduction

As indicated above, wildfires and large-scale fires present complex suppression challenges. Intense heat, high winds, rough terrain, and limited access routes can render conventional firefighting methods ineffective. Aircraft drops are expensive, weather-dependent, and often imprecise. Ground-based apparatus may be too slow, lack range, or be unable to reach remote areas. Additionally, traditional nozzle-based water injection consumes large volumes of water-often hundreds of gallons per minute-leading to rapid depletion of onboard and local reserves and limited operating duration in water-scarce regions.

Accordingly, disclosed below are examples of fluid projecting systems that address these and other challenges. The systems utilize high-velocity airflow sources, such as jet engines or large fans, to deliver fluids, chemicals, or converted water forms across significant distances and with high precision. In some examples, the system is mounted on a stationary platform positioned near an area at risk of fire. In other examples, the system is mounted on a towable or transportable platform. In still other examples, the system is integrated directly with a vehicle. In these configurations, the system can incorporate large-capacity fluid vessels, modular nozzles, and control systems to enable rapid deployment, wide-area coverage, and adaptability to extreme fire conditions.

In some examples, the vehicle is a high-mobility, all-wheel-drive, all-weather firefighting vehicle capable of operating in extreme conditions. The vehicle can also be remotely controllable to allow deployment into fully engulfed forest fires and other hazardous or disaster-prone environments, including industrial sites or energy facilities. Suitable vehicles for mounting or towing the platforms include, for example, trucks, trailers, logging forwarders, skidders, utility vehicles, marine craft, and aircraft.

In some examples, the platform and/or the vehicle includes autonomous or semi-autonomous control features. The platform may also integrate thermal and environmental sensors and employ wireless communication with command systems. These capabilities enable coordinated operation and intelligent fluid delivery based on real-time fire conditions.

Although the fluid projecting platform is primarily described herein for use in firefighting, in some examples, the fluid projecting platform may also be employed in other applications, such as crowd dispersion, agriculture, dust control, environmental cleanup, reforestation, chemical dispersion, or related tasks.

Additionally, as indicated above, traditional fire suppression systems use substantial quantities of water, often hundreds of gallons per minute.

Accordingly, described herein is an ultrasonic humidification system that addresses these problems by delivering mist-based suppression using portable, high-efficiency ultrasonic technology. In one example, the ultrasonic humidification system comprises a group of 120 ultrasonic transducer heads capable of converting water to mist at a total system rate of approximately 16 gallons per hour.

In some examples, the ultrasonic humidification system is small enough to be mounted on a relatively small vehicle, such as in the bed of a pickup truck, or on an all-terrain vehicle (ATV). In this regard, some examples of the vehicle may comprise a jet engine that produces about 100 pounds of thrust, and mist generated by the ultrasonic humidification system may be fluidly coupled to the jet stream. In some other examples, the ultrasonic humidification system may deliver mist to one or more high-powered fans, which may then disperse the mist.

The system provides significantly improved water efficiency compared to conventional direct water injection methods, with the same volume of water lasting approximately six hours in the humidifier system versus only five minutes in conventional systems, while still effectively suppressing fires by maintaining elevated humidity levels in the target area.

### Example Fluid Projecting System

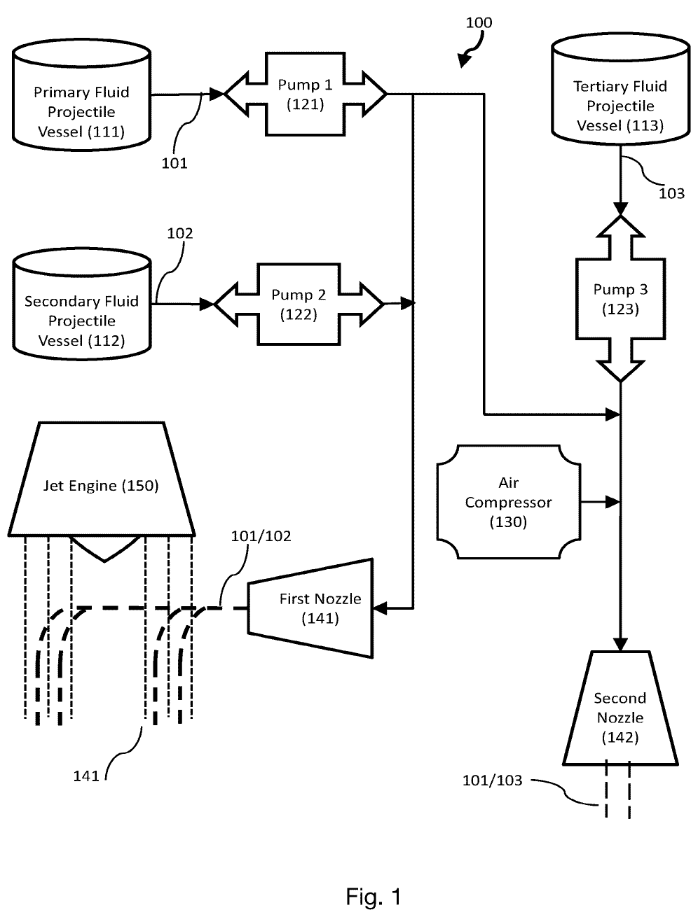

FIG. 1 illustrates a schematic of an example fluid projecting system 100. The system 100 includes a plurality of fluid projectile vessels (111, 112, 113), a plurality of pumps (121, 122, 123), a plurality of nozzles (141, 142), an air compressor 130, and a jet engine 150.

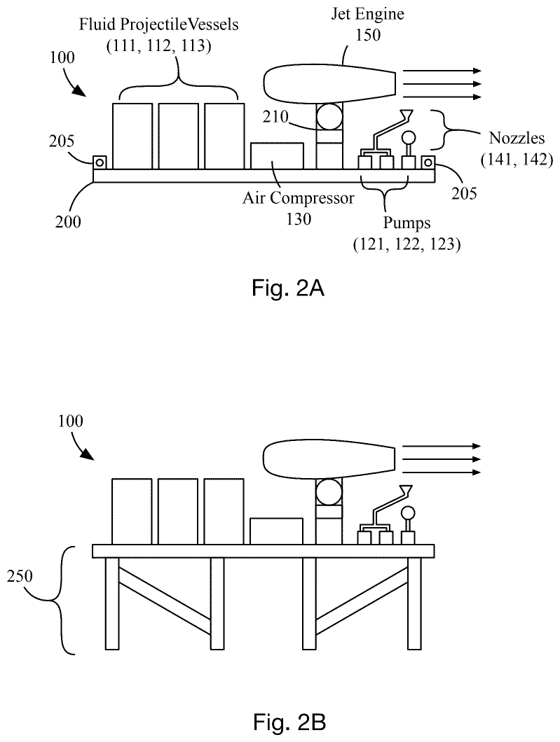

As shown in FIG. 2A, in some examples, one or more components of the system 100 are fixed and/or flexibly coupled to a platform 200, and/or are removably coupled to the platform 200 to facilitate field servicing and component swapping (e.g., to exchange empty tanks for full tanks), thereby reducing downtime and maintaining operational readiness.

Some examples of the platform 200 provide structural support for the components of the system 100. In some examples, the platform 200 comprises coupling elements 205 configured to facilitate lifting of the entire platform assembly, with the mounted components, for placement on a vehicle or for relocation between sites. The coupling elements 205 may comprise one or more of: lifting eyes or attachment points configured for engagement with straps, cables, chains, or hooks; rigging points designed for crane or overhead lifting equipment; manual lifting handles for operator manipulation; or mechanical interfaces configured for automated lifting systems. In some examples, the coupling elements 205 are positioned to provide balanced lifting of the platform assembly and may include safety features such as load-rated components or fail-safe mechanisms.

In some examples, the platform 200 is fabricated as a rigid frame or chassis, while in other examples, the platform 200 may be constructed as a skid, pallet, or modular deck that facilitates transport and installation in a variety of environments. In some examples, the platform 200 is pre-drilled or otherwise configured with standardized mounting points to facilitate secure attachment to a fire truck, logging truck, emergency vehicle, or other transport apparatus.

In some examples, the platform 200 is fabricated from materials selected for structural integrity, durability, and operational requirements. Suitable materials include steel, aluminum alloy, reinforced concrete, engineered plastics, composite materials, or combinations thereof. Steel platforms provide high strength and rigidity for heavy-duty applications, while aluminum alloy platforms offer corrosion resistance and reduced weight for enhanced mobility. Reinforced concrete platforms may be employed for stationary or semi-permanent installations requiring maximum stability and fire resistance. Engineered plastic or composite platforms provide corrosion resistance, reduced weight, and design flexibility for specialized deployment scenarios. The material selection may be optimized based on factors including load capacity requirements, environmental exposure conditions, transportation constraints, and cost considerations.

As shown in FIG. 2B, in some examples, one or more components of the system 100 may be mounted to a support structure 250. The support structure 250 may be configured for semi-permanent or permanent installation, for instance, within an industrial facility, at a wildfire suppression outpost, or on a fixed installation designated for defensive or preventative fire control. In some embodiments, the support structure 250 is anchored to the ground, a building, or another foundation to provide long-term stability under operating loads. In some examples, the support structure 250 incorporates reinforcements, enclosures, or protective housings that shield the components of the system from environmental exposure while maintaining service accessibility.

In some examples, the fluid projecting system 100 comprises a gimbal arm 210 configured to facilitate pivoting/rotating of the jet engine 150. In this regard, in some examples, a first end of the gimbal is coupled to the platform 205, and a second end of the gimbal arm 210 is coupled to the jet engine 150.

As indicated in FIG. 1, in some examples, a first pump 121 and a second pump 122 of the plurality of pumps (121, 122, 123) are fluidically coupled between a primary fluid projectile vessel 111 and a secondary fluid projectile vessel 112 of the plurality of fluid projectile vessels (111, 112, 113), respectively, and a first nozzle 141. These pumps are configured to deliver a primary fluid projectile 101 and a secondary fluid projectile 102 stored respectively within the primary fluid projectile vessel 111 and the secondary fluid projectile vessel 112 to the first nozzle 141. A third pump 123 of the plurality of pumps (121, 122, 123) is fluidically coupled between a tertiary fluid projectile vessel 113 of the plurality of fluid projectile vessels (111, 112, 113) and a second nozzle 142 and is configured to deliver a tertiary fluid projectile 103 stored within the tertiary fluid projectile vessel 113 to the second nozzle 142. One or both of the first nozzle 141 and the second nozzle 142 may comprise a flood, raindrop, hollow cone, full cone, flat fan, or halo nozzle configured to produce a corresponding spray pattern, or a nozzle configured to produce any combination of these spray patterns. In some examples, the air compressor 130 is configured to provide compressed air to the second nozzle 142 to facilitate atomization, pressurization, and extended projection of the tertiary fluid projectile 103, thereby improving spray distribution, penetration, and coverage.

In some examples, the fluid projecting system 100 further comprises a flexible delivery system configured to direct the dispersed fluids to remote locations. The flexible delivery system may comprise one or more fire hoses, flexible conduits, or static piping systems fluidically coupled to receive fluids from the one or more nozzles 141, 142 or from a secondary distribution manifold. In some examples, the flexible delivery system enables the delivery of mist, steam, bubbles, humidified air, or other converted water forms to locations that are remote from the platform 200 or vehicle 300. The flexible delivery system may include reinforced hoses rated for high-pressure applications, articulating joints to accommodate movement and positioning, and terminal nozzles or spray heads configured to optimize fluid distribution patterns at the point of delivery.

In some examples, the jet engine 150 is configured to emit a jet stream of a gas in a direction non-coincident with an output of the first nozzle 141. For example, as shown in FIGS. 1, 2A, and 2B, in some examples, the jet engine 150 emits a jet stream of a gas in a direction substantially perpendicular to an output of the first nozzle 141. This non-coincident orientation allows the high-velocity airflow generated by the jet engine 150 to entrain, carry, and disperse the fluid stream projected from the first nozzle 141, thereby extending its effective range and improving atomization, coverage, and penetration of the delivered fluid. In some examples, the perpendicular configuration also prevents direct interference or obstruction between the nozzle discharge and the jet effluent, allowing the system to maintain consistent spray characteristics while harnessing the jet stream to amplify distribution.

In some examples, the primary fluid projectile 101, the secondary fluid projectile 102, the tertiary fluid projectile 103, or any combination thereof comprises (i) firefighting agents such as water, foams, retardants, or thermal barrier gels; (ii) chemical modifiers such as surfactants, dispersants, or oxygen scavengers; and/or (iii) specialized fluids for non-fire applications such as agricultural sprays, corrosion inhibitors, or bio-agents.

In some examples, one or more of the plurality of fluid projectiles (101, 102, 103) is an airborne aqueous compound, such as an oxygen-scavenging water admixture. The aqueous compound can functionalize graywater as a wet or vaporized cloud to cool and blanket open flame. In other examples, it provides rheological modification to water for use as a dispersed extinguishment aid. In some examples, the aqueous compound comprises a bio-based dispersant, such as the commercially available formulation Fire Out®, which can act as a foam booster in protein- and surfactant-based dense foams and can rapidly blend with high-pH waste water, pond water, or salt water. In some examples, the aqueous compound comprises an in-situ rheological aid for high-shear water streams, producing thickened or bodied water that functions as a hydrogel medium for longer-term coverage of smoldering debris. As a coalescent chemistry, the compound can extend saturation duration as a bound-water nanoencapsulant, thereby reducing water consumption.

In some examples, the fluid projecting system is used for restoring and rehabilitating areas devastated by fire, either during suppression activities or afterward once conditions have stabilized. In this regard, in some examples, the airborne aqueous compound comprises a nutrient-based fertilizer or seed germinator configured for revegetation, hydro-seeding, and soil amendment. In some examples, the compound functions as a restorative binder or stimulant. In further examples, the compound is provided as a fluid-applied natural emulsion incorporating odorless fish emulsions and enzymes to promote soil recovery and plant regrowth.

Some examples of the jet engine 150 correspond to a turbine of a scale comparable to those used on small aircraft or those used on large aircraft. Suitable examples include compact turbojet or turbofan engines adapted from general aviation aircraft, larger turbofan or turboprop engines used in commercial aircraft, and industrial gas turbines configured for stationary or vehicular use. Commercial suppliers of such engines include, for instance, Pratt & Whitney, Honeywell, General Electric, Rolls-Royce, and Williams International. Selection of the jet engine 150 may be based on desired thrust, fuel efficiency, portability, or integration requirements of the platform 100 or vehicle.

In some examples, the jet engine 150 comprises a vector control mechanism configured to adjust the angle of the jet stream relative to the attachment point at the second end of the gimbal. This allows fine directional control of the exhaust flow without requiring gross repositioning of the entire gimbal arm. In some examples, the jet engine 150 further comprises a nozzle assembly that adjusts the cross-sectional shape of the jet stream. The nozzle may be selectively configured, for example, to provide a narrow high-pressure stream for penetration or a widened dispersal stream for broad coverage, with the cross-sectional shape being dynamically adjustable during operation.

In some examples, the platform 100 comprises a single jet engine 150. In some examples, the jet engine 150 comprises a battery, a fuel tank, a fuel pump, or any combination thereof. In some examples, such as when the platform is mounted to and/or integrated within a vehicle, the battery, the fuel tank, the fuel pump, or any combination thereof may be coupled to corresponding components of the vehicle.

In some examples, the jet stream generated by the jet engine 150 is sufficiently powerful that the jet stream can remove tree limbs, sticks, and other flammable materials into an area of already burnt material to form a firebreak. In some examples, a jet stream formed by the jet engine 150 also cools air around or near flames.

In some examples, the jet engine 150 is configured to propel the primary fluid projectile 101 at an effective flow rate between about 500 gallons per minute (gpm) and about 8,000 gpm. In some examples, the effective flow rate is established by varying one or more operating parameters, including pump output, nozzle configuration, jet engine thrust, and entrainment of the fluid stream by the jet exhaust (e.g., via a venturi effect). In some examples, the flow rate is continuously adjustable or selectable at predetermined increments within the range.

In some examples, the jet engine 150 is configured to propel the primary fluid projectile 101 at a speed between about 50 miles per hour (mph) and about 500 mph, the speed being continuously adjustable or settable at predetermined increments within the range.

In some examples, the jet engine 150 is configured to propel the primary fluid projectile 101 to a distance between about 10 feet and about 800 feet, the distance being continuously adjustable or settable at predetermined increments within the range. In some examples, the jet engine produces airflows in excess of about 250 mph at 10 feet (400 kph at 3 meters), about 150 mph at 150 feet (240 kph at 46 meters), and about 100 mph at 470 feet (160 kph at 146 meters), sufficient to strip grass, brush, small trees, debris, and loose soil from the ground to create an effective firebreak.

In some examples, the platform and/or the jet engine 150 comprises sufficient fuel capacity to support continuous operation for durations between about 6 hours and about 24 hours, depending on fuel efficiency of the engine and prevailing operating conditions. In some examples, the jet engine 150 integrates a fuel tank for storing combustible fuel to drive the engine, a fuel pump for delivering the fuel at appropriate pressure and flow rates, and a battery for providing electrical power to onboard systems. In other examples, such functions—such as supplying electricity, fuel, or pumping capacity—are instead provided by the platform or by a host vehicle's corresponding systems (e.g., the vehicle's electrical system, fuel tank, or fuel pump).

Although FIGS. 1-2B illustrate a single jet engine 150 for clarity, in some examples, the platform 100 may include more than one jet engine 150.

In some examples, the platform 100 comprises a suite of sensors configured to perceive environmental and operational conditions. These may include, for example, a GPS sensor, infrared sensors, LIDAR sensors, laser or optical rangefinders, and/or a range finder sensor. In some examples, the platform 100 further comprises a wireless communication system, such as a satellite link, a cellular communication system, or both, to facilitate remote connectivity, data exchange, and coordination with command structures. In this regard, some examples of the platform are configured to receive tasking, prioritization, and situational intelligence from an external artificial-intelligence-enabled command and control system. As described in further detail below in connection with the AI-based wildfire management system, such a system can comprise a fire analysis server (FAS) node hosting machine learning modules and connected to surveillance devices and command-and-control entities over a wireless network. The AI system may acquire sensory data, historical wildfire suppression data, and available resource inventories; generate predictive models; and output asset allocation parameters or suppression strategies. The received information may include fire progression forecasts, optimal deployment locations, or coordinated suppression strategies, which can be used by the onboard controller to autonomously or semi-autonomously direct gimbal orientation, nozzle settings, and fluid delivery patterns.

In some examples, the platform 100 further comprises an onboard controller configured to process sensor inputs and communication data. In some examples, the controller executes computational fluid dynamics (CFD) models in combination with machine learning algorithms trained on prior fire progression maps, thermal imagery, and wind forecast data. For example, convolutional neural networks (CNNs) may analyze infrared sensor streams to identify hotspots, while reinforcement learning models adjust gimbal orientation and nozzle selection in real time. These AI techniques enable autonomous or semi-autonomous operation, including optimized spray pattern selection, jet-stream vector control, and automated generation of preventative firebreaks. Infrared and heat-detecting sensors can be used to identify temperature profiles within a fire zone, while satellite/GPS data support connected positioning and operation in remote areas.

In some examples, actuator systems execute the controller's commands to carry out fire suppression. For instance, the jet effluent nozzle may include deflectors that adjust the airstream from a narrow high-pressure stream (for debris clearing or digging firebreaks) to a wide dispersal stream (for mist, foam, or gel coverage). Smart delivery controls may automatically adjust based on wind, mist density, foam quality, or protective gel distribution. The system may further comprise positioning devices including GPS-guided servo systems, laser targeting systems, infrared tracking devices, or automated positioning mechanisms that enable precise directional control of the gimbal arm 210 and attached jet engine 150. Thermal sensors may confirm when structures have received sufficient insulation. Satellite telemetry sensors may relay real-time environmental conditions (wind speed, humidity, barometric pressure, temperature) back to incident command. In some examples, the platform further comprises specialized emitters for applying structure-enveloping fire stopping barriers and thermal protection coatings.

In some examples, the fluid projecting system 100 is further configured to operate in conjunction with an ultrasonic humidification system 400 as described below. For instance, mist generated by ultrasonic transducer modules 410 may be fluidly introduced into one or more of the nozzles 141, 142 or into the exhaust of the jet engine 150 via a venturi or conduit interface. This arrangement allows the high-velocity jet-stream to entrain and distribute the fine aerosolized mist, thereby extending its effective range, improving particle dispersion, and enhancing localized humidity control around fire lines.

In other examples, the ultrasonic humidification system 400 is mounted on the same platform 200 or support structure 250 as the fluid projecting system 100 or integrated into the chassis of the vehicle 300. In these configurations, the humidification system may share power and control infrastructure with the projecting system, such that its power supply modules 450 and mist output parameters are coordinated by the same onboard controller that directs nozzle orientation, jet vectoring, and fluid delivery. In this manner, the misting and projecting systems operate as complementary modes of suppression: the fluid projecting system 100 delivers high-capacity fluid streams for direct knockdown, while the ultrasonic humidification system 400 sustains elevated humidity and fine mist coverage to slow fire spread and cool adjacent areas.

### Example Vehicle

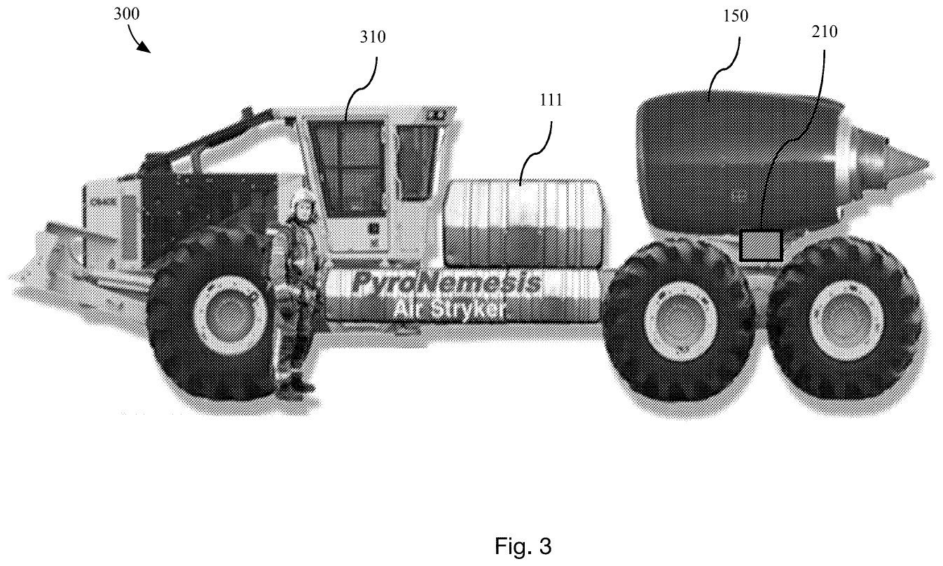

FIG. 3 illustrates an example vehicle 300 that comprises an example integrated fluid projecting system 100. In some examples, the vehicle 300 is a tracked or wheeled all-terrain forwarder or skidder designed for mountainous areas, remote hills, or marsh zones. Some examples of forwarders and skidders are used daily in rough remote forests to remove logs and grade trails for access and removal of timber and have an existing hydraulic system adequately used for agile movements of its lifting boom, plow, winch, and attachable accessories. In some examples, the lifting boom is a multi-positional hydraulic boom and is configured to be coupled to a jet turbine, a cutter/feller, an air duct, a fluid delivery nozzle, or another attachment useful in combating fire.

In some examples, the weight of the vehicle 300 is sufficient to offset jet engine recoil, its load capacity is sufficient to carry tens of thousands of pounds of fluids, and its mobility is sufficient to traverse terrain inaccessible to conventional fire trucks. Some other examples of the vehicle 300 comprise a car, truck, trailer, tractor, bus, minibus, backhoe, bulldozer, excavator, forwarder, skidder, dump truck, front loader, logging forwarder, all-terrain vehicle, or any combination thereof.

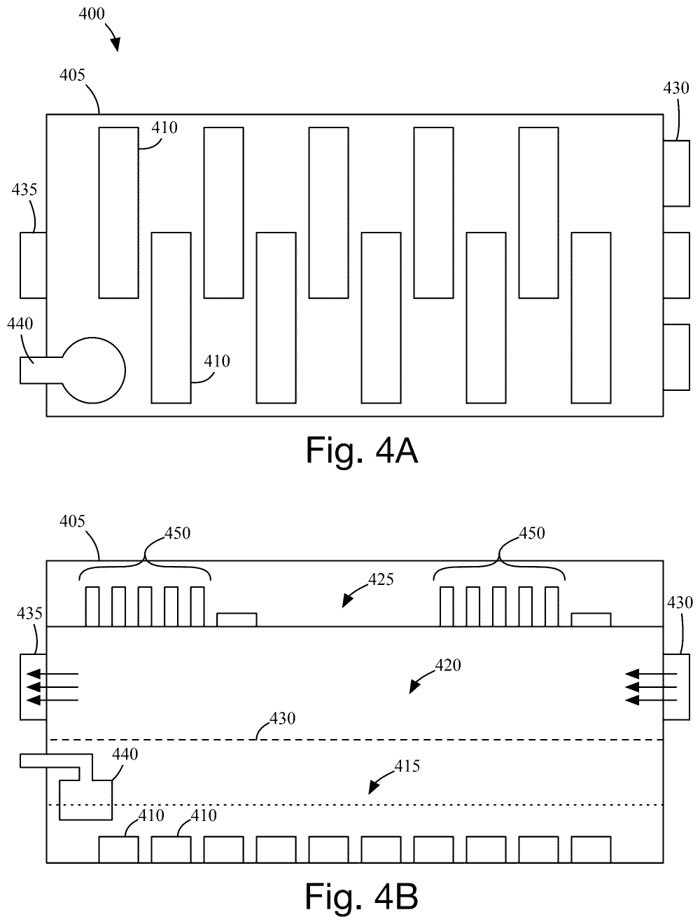

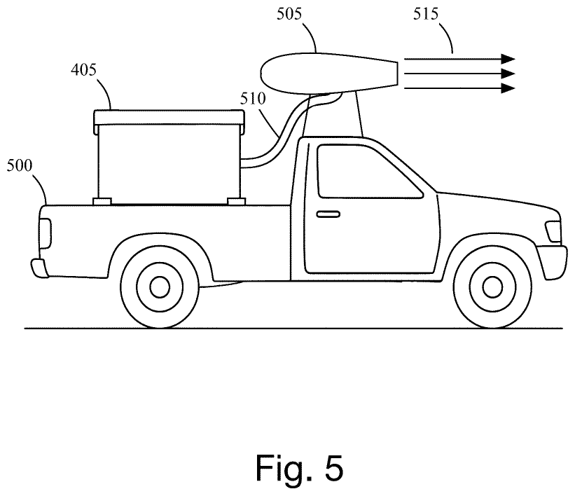

In some examples, the vehicle 300 further comprises or supports an ultrasonic humidification system 400, such as that shown in FIGS. 4A-5, in addition to the fluid projecting system 100. In these configurations, mist output from the ultrasonic system may be entrained into the jet exhaust of the jet engine 150 or combined with nozzle discharge 141, 142, thereby allowing the vehicle to deliver both high-volume fluid projection and fine misting for extended humidity control and flexible suppression strategies.

In some examples, the vehicle 300 is human-operated and includes an operator cabin 310. The operator cabin 310 may include one or more of a heat shield, a radiation shield, a positive pressure system, an air purifying system, a thermal imaging system, an air conditioning sensor, a chemical sensor, or any combination thereof. In some examples, the vehicle further comprises thermal barrier media applied to exterior surfaces, tanks, or engine components, in addition to operator shielding, to insulate and protect both operators and apparatus from radiant heat. These features facilitate safe operation and driving of the vehicle in extreme or hazardous environments such as forest fires, war zones, deserts, etc. In some examples, operators are protected by a heat shield surrounding the cabin and a positive pressure purified air system that filters hazardous biological or chemical contaminants. An SCBA compliant operator's seat may be provided, enabling the operator to wear breathing apparatus during piloting. Some examples of the vehicle 300 comprise overhead and 360-degree obstacle warning sensors to alert the pilot to hazards and, in some cases, override steering or braking to prevent collision. Some examples of the vehicle comprise a 360-degree thermal imaging camera system configured to allow the pilot to see through smoke, detect hotspots, monitor fire temperatures, and identify safe escape routes. These imaging systems may be tied to the onboard computer to prevent accidental targeting of firefighters.

In some examples, the vehicle is an autonomous or semi-autonomous vehicle, and/or is remotely controllable. Mission autonomy may use cameras, radar, and thermal sensors to enable “seek and destroy” hotspot suppression without direct piloting, or via remote operation.

In some examples, the vehicle 300 further comprises a remote operation system including one or more of: a wireless communication module, a satellite communication terminal, a cellular communication module, or a secure internet-connected interface. These modules facilitate bidirectional exchange of control commands, telemetry, and sensor data between the vehicle and a remote operator or command center.

In some examples, the remote operation system further comprises one or more portable control devices configured for hand-held operation by personnel in the field. The portable control devices may include handheld controllers, tablet computers, smartphone applications, or dedicated remote control units equipped with wireless communication capabilities. These portable devices enable operators to control gimbal orientation, jet engine thrust, nozzle selection, and fluid delivery parameters from locations remote from the vehicle or platform. In some examples, the portable control devices include safety features such as dead-man switches, authorization protocols, and range limitations to ensure safe operation. The portable control devices may communicate with the onboard controller via encrypted wireless protocols including WiFi, Bluetooth, cellular networks, or proprietary radio frequency systems.

In some examples, the vehicle 300 is configured to integrate with an external AI-based Wildfire Management System as described herein. The vehicle's onboard controller may receive tasking, prioritization, and suppression directives generated by the AI-based Wildfire Management System and process such instructions in conjunction with its local sensor inputs. In this manner, the vehicle 300 can autonomously or semi-autonomously navigate, orient its platform 200, and deliver fluids in accordance with coordinated suppression strategies and predictive allocation parameters output by the AI-based Wildfire Management System.

In some examples, the vehicle weighs about 60,000 pounds and can carry an additional 40,000 pounds of fluids or granular solids. In some examples, the vehicle has an outer width of at most about 9 feet. In some examples, the vehicle has a carrying capacity of at least about 50,000 pounds. In some examples, the width, the carrying capacity (or both) ensure its ability to maneuver through a wide array of terrains, including but not limited to: city streets, canyons, tunnels, and bridges.

In some examples, the vehicle 300 comprises a weight distribution system that may include one or more support feet, axle load detectors, bladders, ballast tanks, or any combination thereof. Examples of the elements may be repositioned to optimize stability under thrust imparted on the vehicle and generated by the jet engine 150. Some examples of the weight distribution system are configured to facilitate operation of the vehicle across a variety of terrains, including stable and unstable ground, high winds, and steep slopes. In some examples, pitch, roll, and yaw sensors may be integrated with axle load detectors to maintain ground stability. Auto-throttle controls and gimbal tilting may prevent jet-induced rollover, and ballast bladders may dynamically reposition fluid to optimize stability.

### Example Misting System

In addition to the fluid projecting platforms 100 and vehicle-mounted systems described above, the disclosure also provides an ultrasonic humidification system 400 that can be deployed independently or in combination with those systems to improve water efficiency and mist-based suppression. In some examples, the humidification system 400 may also serve as a source of liquid or atomized mist that can be entrained into or projected by the jet engine 150 or other high-velocity airflow source described herein, thereby extending the functionality of the platform 100.

FIGS. 4A and 4B illustrate top and side views, respectively, of an example ultrasonic humidification system 400 suitable for fire suppression applications. In some examples, the ultrasonic humidification system 400 and other water conversion technologies described herein may be collectively referred to as a “water conversion apparatus.” The water conversion apparatus encompasses any system, device, or combination of devices configured to convert liquid water into airborne moisture forms, including mist, steam, bubbles, or humidified air, for fire suppression applications. In some examples, the water conversion apparatus may utilize alternative or supplementary conversion technologies, including vaporization chambers, atomization systems using compressed air injection, mechanical agitation systems, electrospray ionization systems, or any combination of physical, chemical, or electrical processes configured to convert liquid water into airborne moisture.

Referring to the figures, the humidification system 400 comprises a housing 405 and one or more ultrasonic transducer modules 410 disposed within the housing 405. Some examples of the housing 405 define a water reservoir 415, a misting chamber 420 above the water reservoir 415, and a waterproof chamber 425. In some examples, the water reservoir 415 is sized to hold 3 gallons of water and 120 ultrasonic heads. In some examples, the ultrasonic transducer modules 410 are arranged within the water reservoir 415, such as along the bottom surface of the reservoir 415. Some examples of the water reservoir 415 comprise a water level control apparatus 440 configured to regulate the amount of water held within the reservoir 415. For instance, some examples of the water level control apparatus 440 maintain the water at a consistent depth to provide a consistent water height above the ultrasonic transducer modules 410 (e.g., about 2 inches). Maintaining proper depth ensures misting effectiveness and protects the transducers from overpressure or underperformance. In some examples, the water level control apparatus 440 corresponds to a mechanical float valve. In some other examples, the water level control apparatus 440 may include a control circuit that senses the water level (e.g., via a water level switch, capacitive sensor, optical sensor, etc.) and controls a valve to open and close to maintain a consistent water level within the reservoir 415. In some examples, the control circuit may simultaneously activate and deactivate a pump that fluidly couples the reservoir (e.g., via the valve) to a water source when opening and closing the valve, respectively.

In some examples, the ultrasonic transducer modules 410 comprise one or more ultrasonic transducer heads. Some examples of the ultrasonic transducer head comprise a piezoelectric ceramic element bonded to a metal diaphragm that is driven by an oscillator and amplifier circuit. In some examples, each ultrasonic transducer head operates in a frequency range of approximately 1.6 to 2.4 MHz to produce high-frequency mechanical vibrations that atomize water into micron-sized droplets. In some examples, each ultrasonic transducer head consumes approximately 30 to 40 watts and is thermally managed by submersion in water. In this regard, in some examples, each ultrasonic transducer module 410 is powered by its own power supply module 450.

In one particular example, the ultrasonic humidification system 400 comprises ten ultrasonic transducer modules 410, each having its own dedicated power supply module 450, and each ultrasonic transducer module 410 comprises twelve ultrasonic transducer heads for a total of 120 ultrasonic transducer heads. In this example, during operation, each ultrasonic transducer module 410 may draw approximately 300-400 watts and the ultrasonic humidification system 400 may draw approximately 3,000-4,000 watts. In this example, the ultrasonic humidification system 400 may convert water to mist at a total system rate of approximately 16 gallons per hour. In some examples, the actual misting output varies based on environmental conditions, water quality, and system duty cycle. It is understood that the rate may be increased or decreased as needed by changing the number of ultrasonic transducer modules 410 and/or the number of ultrasonic transducer heads on each ultrasonic transducer module 410. It is also understood that the number of ultrasonic transducer heads on the various ultrasonic transducer modules 410 or the total number of ultrasonic transducer heads may be different. For instance, in some examples, the ultrasonic humidification system may comprise a single ultrasonic transducer head of sufficient size and power (e.g., a single 3,000-4,000 watt ultrasonic transducer head) to generate the required mist output for fire suppression applications.

In some examples, the misting chamber 420 is configured to receive mist generated by the ultrasonic transducer modules 410. In some examples, the misting chamber 420 comprises one or more air intake openings 430 and one or more mist output openings 435. In some examples, one or more fans or blowers are positioned within the misting chamber 420 to facilitate airflow through the misting chamber 420. For example, one or more fans/blowers may be positioned within or proximate to the air intake openings 430 and/or the mist output openings 435.

In some examples, the misting chamber 420 comprises a mist/droplet screen 430 positioned between the reservoir and the mist openings 430, 435. In some examples, the mist/droplet screen 430 is configured to intercept and retain larger water droplets or splashes, such as those generated by turbulence or incomplete atomization. In some examples, the mist/droplet screen 430 comprises perforations or mesh openings sized to allow only fine aerosolized mist to pass through, thereby ensuring consistent particle size and preventing the introduction of bulk liquid into the mist output path. In some examples, this prevents water loss due to sloshing or flooding and protects downstream airflow components.

In some examples, the housing 400 comprises a waterproof section comprising electrical components that require electrical isolation. In some examples, the power supply modules 450 are arranged within the waterproof section and electrically isolated for safety. In some examples, a dedicated generator mounted on the vehicle powers the humidifier system independently of the vehicle's primary electrical system.

FIG. 5 illustrates an example ultrasonic humidification system 400 mounted on a vehicle 500. In some examples, the ultrasonic humidification system 400 is installed on a vehicle 500 that is also equipped with a high-velocity airflow source 505. In some examples, the vehicle 500 comprises relatively small and maneuverable platforms, such as pickup trucks, all-terrain vehicles (ATVs), or utility task vehicles (UTVs), which are suitable for operation in rugged or remote environments. In other examples, the ultrasonic humidification system 400 and the high-velocity airflow source 505 may be mounted on larger platforms, including mobile fire trucks, railway cars or locomotives, marine vessels, such as boats or ships, and aircraft, including helicopters or fixed-wing airplanes.

In some examples, the ultrasonic humidification system 400 and the high-velocity airflow source 505 are provided as a combined assembly mounted on a platform. In some examples, the platform may be installed on a mobile vehicle, such as a pickup truck, utility terrain vehicle (UTV), or other transportable apparatus. In other examples, the platform may be positioned on a stationary structure, such as within an industrial facility, at a wildfire suppression outpost, or on a fixed installation configured for defensive or preventative fire control.

In some examples, the high-velocity airflow source 505 is configured to generate airflow in the range of approximately 100 CFM, 1,000 CFM, or even greater, depending on the deployment requirements. In some examples, the high-velocity airflow source 505 corresponds to a modestly powered jet engine, such as one generating approximately 100 pounds of thrust, as commonly used on small aircraft. In some examples, the airflow source may alternatively correspond to a larger jet engine used in commercial aviation. In other examples, the high-velocity airflow source 505 comprises an axial fan, centrifugal fan, blower, turbofan engine, propeller-driven system, or any other mechanical device capable of generating sufficient airflow to entrain, transport, and distribute the mist generated by the ultrasonic humidification system 400.

In some examples, mist generated by the ultrasonic humidification system 400 is drawn into the engine exhaust stream 515 via a venturi interface 510, where the high velocity of the jet engine exhaust stream 515 creates a vacuum that pulls the mist from the ultrasonic humidification system 400 into the suppression flow. In some examples, the venturi interface comprises a conduit or Y-junction arranged such that the mist is introduced tangentially or at an angle to the high-velocity airflow path, thereby enhancing entrainment efficiency. This humidified air stream can then be directed toward a fire, where even slight increases in humidity around the fire greatly reduce fire spread speed.

In some examples, the ultrasonic humidification system 400 may deliver mist to one or more high-powered fans, and these fans may then disburse the mist over a designated area. In some examples, the mist output port of the ultrasonic humidification system 400 is fluidically connected to the intake side of a high-powered axial or centrifugal fan. In some examples, the fan is positioned to direct the aerosolized mist across a wide coverage zone, such as along a fire line, around critical infrastructure, or in areas prone to wildfire ignition. In some examples, the fan may be mounted on a stationary platform, a vehicle, or a rotating turret to enable dynamic control of mist direction. In some examples, the fan and mist system may be configured to operate autonomously or under remote control. In some examples, the fan-based delivery system provides a lower-cost alternative to jet propulsion-based systems, particularly in urban interface areas or fixed installations. In some examples, this configuration is useful for pre-wetting vegetation, cooling hot spots, or increasing relative humidity in a fire-prone corridor.

In some examples, the ultrasonic humidification system 400 is deployed in conjunction with the fluid projecting system 100 or the vehicle 300. For instance, the housing 405 and reservoir 415 may be mounted to the same platform 200 or vehicle chassis 300 that supports the fluid storage vessels 111-113, pumps 121-123, and jet engine 150. In such cases, mist generated by the ultrasonic transducer modules 410 can be fluidly coupled to the nozzles 141, 142 or entrained into the jet exhaust of the jet engine 150, thereby extending distribution range, increasing entrainment efficiency, and providing fine particle coverage in parallel with bulk liquid delivery. In other examples, the mist output is introduced into airflow generated by auxiliary fans or blowers positioned on the platform 200 or the vehicle 300.

In some implementations, the ultrasonic humidification system 400 shares onboard power and control infrastructure with the fluid projecting system 100, such that the power supply modules 450 are supported by the same generator or electrical system that drives pumps 121-123. The controller that governs nozzle settings and jet vectoring may also coordinate humidification output, enabling intelligent blending of misting and bulk fluid projection. In this manner, the humidification system 400 provides a complementary mode of operation, sustaining localized humidity and cooling while the fluid projecting system 100 delivers concentrated fire suppressants or retardants.

In still other examples, operation of the ultrasonic humidification system 400 is integrated with the AI-enabled command and control framework described herein. The onboard controller may adjust misting intensity, airflow entrainment, or directional output of the humidification system 400 in coordination with nozzle selection, gimbal orientation, and vehicle positioning, thereby offering a unified and adaptable suppression capability across multiple modalities.

### AI-Based Wildfire Management System

The following section discloses an example AI-based wildfire management system, methods performed by the system, and computer-readable medium of the system. Some examples of the Wildfire Command AI system are configured to allocate and manage fire suppression resources, including equipment, water supplies, and personnel. In some examples, the Wildfire Command AI system employs fine-tuned models derived from pre-trained predictive models to analyze wildfire-related data irrespective of format, style, or type. By leveraging these predictive models, the Wildfire Command AI system addresses shortcomings of conventional fire mitigation approaches and provides improvements over the solutions described in the background section.

In some examples, the Wildfire Command AI system is configured to exchange data with fire suppression platforms, such as the example fluid projecting system 100 or vehicles 300 described herein. Sensor streams, actuator status, and fluid inventory levels from the projecting systems may be provided as inputs to the fire analysis server (FAS) node, thereby enriching the predictive models with real-time ground-truth operational data.

In some examples, the Wildfire Command AI system provides for AI and machine learning (ML)-generated parameters based on analysis of wildfire-related data. In some examples, an automated decision/recommendation model may be generated to provide for fire suppression equipment usage and allocation recommendation parameters associated with the current filed fire situation. The automated decision/recommendation model may use historical fires' data collected at the current location (i.e., an annual seasonal wildfire site) and at wildfire sites facilities of the same type located within a certain range from the current location or even located globally. The relevant fires' data may include data related to other fires and equipment employed having the same parameters such as size, location, weather conditions, fire parameters, etc. The relevant fires' data may indicate successfully mitigated wildfire cases and indication of equipment used for wildfire mitigation and the location(s) where the successful mitigation/suppression was performed. This way, the best matching set of equipment may be assigned to respond to a given wildfire site based on current fire-related data and historical data of mitigation of wildfires having the same characteristics such as size, intensity, rate of spreading, ambient conditions, location, etc., as well as predicted fire behavior as conditions change.

In some examples, the AI/ML technology may be combined with a blockchain technology for secure use of the wildfire-related data and wildfire-related surveillance data. In some examples, the fire analysis entities (e.g., unmanned vehicles, drones, etc.) may be connected to the fire analysis server (FAS) node over a blockchain network to achieve a consensus prior to executing a transaction to release the asset allocation recommendations for the current wildfire site based on the asset allocation recommendation parameters produced by the AI/ML module. The Wildfire Command AI system may utilize asset allocation-related data based on the fire analysis and the fire command-and-control entities being on-boarded to the Wildfire Command AI system via a blockchain network.

In contrast with existing software-based systems that incorporate data to predict fire movement and then leave it to the user to figure out how to act on that information, the Wildfire Command AI system application described herein may be configured to formulate actionable suppression strategies based on available resources and priorities. The Wildfire Command AI system may further be configured to unsilo accumulated fire knowledge and data that resides in hundreds of independent disjointed data sources, such as government agencies, universities, among others, and integrate it into a single source of actionable information and maximally informed suppression plans.

In some examples, outputs of the Wildfire Command AI system include explicit control directives or recommendations tailored for the Example Fluid Projecting System 100 or vehicle 300. These outputs may comprise, for instance, nozzle mode selection (mist vs. stream), jet engine thrust levels, gimbal orientation commands, or deployment routes for vehicles carrying suppression systems. The onboard controller of the projecting system or vehicle may then execute these directives autonomously or semi-autonomously.

In some examples, the Wildfire Command AI system comprises one or more of an advanced pyrotechnic-informed, sensor-integrated, dynamic AI-driven decision support system for superior real-time wildfire management and suppression.

In some examples, the Wildfire Command AI system includes or incorporates one or more sensors. For example, the Wildfire Command AI system may be configured to integrate inputs from a plurality of sensors. In one example, the Wildfire Command AI system comprises a sensor input module configured for comprehensive sensor input integration. The sensor input module may integrate inputs from a multiplicity of sensors. In one configuration, the sensor input module may be configured to dynamically select sensors for data queries. Each sensor may be selected and calibrated for its potential to provide valuable insights into wildfire behavior. Additionally, sensors may be selected for their potential to provide insights that the Wildfire Command AI system uses to alert users to additional hazards.

The Wildfire Command AI system may be configured to integrate data feeds from an unlimited number of individual or clustered sensors, including but not limited to all or any combination of, including any known or future developed sensors, selected from: location inputs, including those of satellite navigation systems, such as global navigation satellite systems, e.g., global positioning system (GPS); environmental sensors configured to measure environmental conditions such as wind speed, wind direction, ambient temperature, humidity, barometric pressure, or ultraviolet radiation exposure; geographic conditions such as ground slope angle and its orientation relative to the sun; biota or ecological sensors such as vegetation moisture probes, vegetative density sensors, vegetation type identifiers, or soil moisture probes; optical sensors such as high-resolution video feeds, infrared cameras and sensors, or high-resolution still imagery cameras; acoustic sensors; gas analyzers or chemical detectors, including any combination of, but not limited to: O2, O3, CO, CO2, NO, NO2, H2SO4, chlorine compounds, propane, methane, benzene, acrolein, polycyclic aromatic hydrocarbons (PAHs), volatile organic compounds (VOCs), hydrogen cyanide (HCN), sulfur dioxide (SO_2), ammonia (NH_3), particulate matter (PM2.5 and PM10) or other chemicals that may be present at, released or diminished by wildfire activity; air quality monitors; radiation detectors; microwave radiometry; radar systems, such as doppler, soil composition sensors; electromagnetic field (EMF) sensors; motion sensors; ground vibration monitors, thermal radiometers, lightning detection devices; or decibel meters.

The Wildfire Command AI system may comprise or utilize inputs for integration obtained by LIDAR systems, HADAR systems, satellite imagery, data input from specialized fire movement & behavior programs, external POI maps, or topographic data, including any combination thereof.

The Wildfire Command AI system may comprise an analysis module configured to analyze inputs, which may be utilized by the Wildfire Command AI system to generate outputs as described herein. In some examples, the analysis module comprises an AI submodule. In this or other examples, the analysis module comprises a data analytics submodule. The analysis module may include one or more machine learning (ML) algorithms. The algorithms may incorporate supervised, unsupervised, and reinforcement learning frameworks. The algorithms may be employed to ensure accurate wildfire spread predictions, potential shifts in behavior, enable modeling of optimal suppression actions, or a combination thereof. The analysis module may be configured with computer vision techniques for application to inputs. The computer vision techniques may include capabilities spanning object detection, segmentation, and real-time video analytics, crucial for early fire detection and trend prediction, or the like. The analysis module may be configured to perform dynamic data processing. The processing may include rapid processing and real-time analytics of data from diverse sources to ensure up-to-the-moment insights. The analysis module may employ continuous learning mechanisms. For example, the analysis module may be configured with AI models that adapt and refine their predictive accuracies and strategic recommendations based on incoming data streams and previously integrated models. In some examples, the analysis module includes or is configured to utilize quantum computing. For example, delineated segments of a suppression plan may be routed to quantum computing resources for analysis and processing, with their outputs then plugged back into the AI.

The Wildfire Command AI system may be configured with an adaptive strategy design for data analysis and output generation. For example, AI models may be informed by physics, chemistry, meteorological, pyrotechnic, and other insights, and trained on vast amounts of prior fire data to speedily craft strategic plans for containment and suppression that are both dynamic and scientifically rigorous. In one configuration, the Wildfire Command AI system is configured with real-time adaptability. For example, the Wildfire Command AI system may be configured for immediate recalibration and re-issuance of suppression strategies based on continuously evolving fire conditions. In this or another configuration, the Wildfire Command AI system is configured for optimal resource deployment. Resource allocation strategies, for instance, may be configured to maximize crew safety, civilian safety, suppression efficacy, and the safeguarding of prioritized assets.

The Wildfire Command AI system may be configured with a resource and priority drive response framework. For example, the Wildfire Command AI system may actively solicit information about available local and national fire response resources as additional inputs. The Wildfire Command AI system may be configured to automatically query such resources. For instance, when used in communities where computer-aided dispatch systems are used, the Wildfire Command AI system may query these systems automatically to determine what equipment, personnel, and other resources are available. The Wildfire Command AI system may take inventory of available assets for incorporation in generated response plans. Example inventories of responding agency assets and resources may include one or more of heavy equipment assets, such as quantity and type of: bulldozers, graders, backhoes, or the like; aerial resources, such as winged aircraft (e.g., fixed-wing, spotters, VLATs, etc.), rotary lift aircraft (e.g., helicopters of various capabilities); vehicular assets (e.g., type 1 trucks, type 2 trucks, type 3 trucks, type 4 trucks, type 5 trucks, type 6 trucks, type 7 trucks, pickup trucks, conventional UTVs, remote-controlled and autonomous UTVs and vehicles, water tenders); marine assets (e.g., type 1 boats, type 2 boats), including any combination thereof. Asset and resource inventories may also include personnel (e.g., command staff, supervisory staff, firefighters, hand crews, specialized crews, drone operators, communications crews, public information officers); water sources (e.g., hydrants, oceans, rivers, lakes, streams, ponds, swimming pools, storage tanks, water treatment plants); hand tools (e.g., chainsaws, rakes, hoes, axes, Polaskis, drip torches, flappers); Team Wildfire assets (e.g., Hurricane, Cloud Burst, Storm Cell, Thunder Head); UAV/UAS assets (e.g., drones, unmanned helicopters); consumables (e.g., suppressants, retardants, foams, gels, accelerants); support services (e.g., food, lodging, sanitation), or any combination thereof. As stated above, some or all of this list of available fire suppression assets may be prepopulated into an incident's data set by querying the dispatch software of nearby fire agencies to determine which of that organization's assets are currently deployed elsewhere and which assets are available.

In certain implementations, the Wildfire Command AI system incorporates platform and vehicle-specific attributes into its resource allocation algorithms. For example, inventory of available fluid storage vessels 111-113, pump capacities 121-123, jet engine thrust envelopes 150, or vehicle mobility constraints (e.g., terrain limitations of vehicle 300) may be factored into optimal deployment strategies. In this way, the Wildfire Command AI system does not merely allocate abstract “resources,” but can issue actionable plans that map directly to the capabilities of the Example Fluid Projecting System and Example Vehicle.

In some examples, the Wildfire Command AI system may include an ordered list of values at risk (OLIVAR) module. The OLIVAR module may solicit and incorporate protection priorities as additional inputs. The Wildfire Command AI system may utilize protection priorities to calibrate output. For example, the prioritized protection may be used by the analysis module, e.g., AI submodule, to calibrate its output strategies based on the importance of assets at risk. In some examples, the assets at risk may include hospitals, schools, residences, transportation infrastructure (e.g., airports, train stations, ports, parking lots, bridges), energy infrastructure such as power plants (e.g., nuclear, wind, hydroelectric), businesses, industrial sites, historical sites, data centers, streams, reservoirs, lakes, military assets (e.g., bases, depots, equipment, installations), among others.

In some examples, the Wildfire Command AI system includes or communicates with a user interface of a computing device configured to query users with respect to asset protection priorities. In a further or another example, the OLIVAR module may be configured to automatically suggest assets for the user to rank, which may be based on publicly available maps that include “points of interest,” based on a fire's current and anticipated position.

As introduced above, the Wildfire Command AI system may be configured to generate outputs. Outputs may be generated and facilitated by an output module based at least in part on analysis data generated by the analysis module. In some examples, the output module may generate or facilitate real-time suppression plans, data visualizations, crew allocation and tasking directives, automated assignment of refueling to each vehicular asset, automated routing of water refill trucks, remote commands for interfacing with compatible hardware, feedback loops for suppression strategy refinement, evacuation orders, updated evacuation route planning, supplemental protective measures, automated ordering and delivery of crew meals/water and timing, and immediate issuance and detailed emergency instructions for crew evacuations as conditions deteriorate, through an operational framework for uncompromising a compromised crew (OFUCC) module. The operational framework may include or integrate with mechanical frameworks including communications hardware configured to facilitate robust data communication. The output recommendations of the OFUCC module may be reliably delivered via robust and redundant emergency communications hardware to the crew. For robust and uninterrupted data transmission and command relay, the Wildfire Command AI system may interface with state-of-the-art communications hardware, such as redundant satellite systems, cellular hubs, Bluetooth, WiFi, and new technologies as they become available. The Wildfire Command AI system may be capable of outputting data to advanced interoperability systems, such as ATAC, Perimeter, and Persistent Systems.

In some examples, the Wildfire Command AI system may integrate with or communicate with reverse 911 and similar systems to automatically notify people in the predicted path of the fire. The analysis module may include a training platform configured to train the AI submodule or AI algorithms thereof. The training sources may include, for example, one or more resource capabilities databases, such as manufacturer specifications of the capabilities and parameters for equipment, historical wildfire databases, weather databases, topographical databases, vegetation and fuel data database, satellite and aerial imagery databases, remote sensing databases, human observations, infrastructure, points of interest, and asset data databases, simulation and modeling data databases, air quality databases, social and economic data databases, research papers and studies databases, communication channels, or any combination thereof. Specifications of the capabilities and parameters of equipment may include, for example, an XYZ truck can travel 60 mph on zero slope, laden with a full tank, 30 mph on a 25-degree slope, and cannot climb steeper than a 60-degree slope. It can carry 2,000 gallons of water. It can operate on lateral surfaces of up to 20 degrees of slope. It can apply water over a distance of 200 feet from the truck. The fuel tank holds 150 gallons, which gives it an operational time of 16 hours between refills. This data is used to help the Wildfire Command AI system in its strategic chess game against a fire. Historical wildfire databases may include third-party sources.

Such databases may include data such as drone data, aircraft sensor data, real-time fire behavior, or the like. Human observations may include sources such as reports from local fire departments or community platforms. Such databases may include data such as first-hand observations from firefighters, public reports, or the like. Such databases may include data such as location, number, or other specifics with respect to homes, businesses, schools, hospitals, industrial sites, military sites, roads, power lines, water sources, firefighter resources, or the like.

The AI submodule may be configured with various AI architectures for performing its operations and may include additional submodules, as needed. In some examples, the AI submodule is configured with sensor fusion architecture wherein a distributed sensor ingestion framework handles, e.g., millions of concurrent data streams from heterogeneous sensors for real-time processing, e.g., via Apache Kafka queues and Flink. A geospatial-temporal indexing scheme may be configured to associate sensor data with location and time for hyperlocal real-time insights. A sensor fusion technique may integrate sensor data based on reliability weights and historical accuracy profiles of each sensor type.

In some examples, the AI submodule is configured with reinforcement learning for optimization configured to formulate one or more resource allocation problem as a Markov Decision Process optimized via asynchronous advantage actor-critic (A3C) algorithms; leverage multi-agent reinforcement learning with interconnected firefighting vehicles/assets as intelligent agents collaborating via deep RL; detail the state (fire data), action (asset deployment), reward (fire containment), and policy (asset control strategy) components.

In some examples, the AI submodule is configured to execute a quantum wildfire simulation that leverages quantum simulation algorithms on quantum hardware, like D-Wave or Honeywell quantum systems, to model wildfire propagation across a digital twin of the environment. Quantum simulation may be configured to provide representations of complex fire and weather dynamics that are intractable for classical computers. The quantum simulation may be configured to perform, e.g., millions of concurrent simulations to evaluate high-risk scenarios and probability outcomes.

In some examples, the AI submodule is configured with quantum machine learning utilizing quantum versions of neural networks, like quantum convolutional neural nets, to analyze visual fire data and sensor streams with higher accuracy. Quantum machine learning may leverage qubit quantum states to massively parallelize data processing and pattern recognition. This may be used to output refined insights into fire hotspots, combustion properties, smoke dispersal patterns, or a combination thereof.

In some examples, the AI submodule is configured to employ quantum optimization. Quantum optimization may apply quantum annealing and quantum approximate optimization techniques to optimize asset allocation, evaluate huge decision spaces of possible asset coordination strategies simultaneously, or a combination thereof. Quantum optimization may be configured to provide superior real-time logistics under rapidly evolving conditions.

In some examples of the Wildfire Command AI system, a lightning strike in Southern California ignites a wildfire. An Incident Commander is assigned to manage the fire. The Incident Commander logs into the Wildfire Command AI system platform via a digital user interface provided on a computing device. The Wildfire Command AI system platform may present a list of locations, an input field, a satellite image, or the like for identification of fire location. In some examples, the Wildfire Command AI system may output a graphical display for presentation on a display of the user interface that populates with known fire locations. In this example, the Incident Commander pulls up a satellite image of the area, identifies the fire, and clicks on it. This triggers the Wildfire Command AI system to begin logging data from sensors in the area. The analysis module may make an initial assessment of the current size, severity, and projected movement of the fire, based on the Wildfire Command AI system's knowledge base of the topography of the area and current weather and fuel conditions. The system may prompt the Incident Commander to answer questions pertaining to available resources, such as the number and type of fire trucks, crew, airplanes, etc. The Wildfire Command AI system may source some of this asset data by querying the Computer-Aided Dispatch systems of nearby fire agencies to determine which of their assets are currently deployed and which are available. As these Computer-Aided Dispatch systems are updated, the Wildfire Command AI system may be informed as additional resources become available and will add them to the resources available to be deployed on the current incident.

The Wildfire Command AI system may then access its database of valued assets in the threatened area from a list of Points of Interest, which include a military base, a nuclear power plant, and a hospital. The Incident Commander is asked to rate the protection priorities, and ranks them 1) nuclear plant, 2) hospital, 3) military base. This becomes the Ordered List of Values at Risk (OLIVAR) for this incident.

The analysis module may then run through millions of possible ways to deploy the Incident Commander's available assets, and in seconds, the output module delivers a continuously optimized suppression plan, suggesting to the Incident Commander where each vehicle should park, where to attack the fire first, where to deploy planes and helicopters, where to dig line with bulldozers, etc. Deeper details of the output cover all of the logistics of suppressing a fire, including, but not limited to, the sourcing and distribution schedule of water, fuel, and retardant for fire apparatus, crew meals, crew accommodations, heat load monitoring, crew safety plans, and contingency plans.

With the Incident Commander's approval, the output module may then contact and issue response orders to each of the Incident Commander's assets. The output module may then automatically deploy any remote-control assets, such as drones and autonomous UTVs to survey areas where it needs more data. The output module may also automatically trigger Reverse 911 systems to notify residents and businesses in the area to prepare to evacuate or to evacuate and suggests evacuation routes that are passable. As more vehicles, aircraft, drones, and their onboard sensor suites arrive and begin transmitting data back to the analysis module, the Wildfire Command AI system may update the continuously optimized suppression plan continuously, allowing the Incident Commander to update crew assignments immediately and/or withdraw crews to safety.

The AI-based equipment allocation system may integrate inputs from a multiplicity of sensors, each selected and calibrated for its potential to provide valuable insights into wildfire behavior and to alert users to additional hazards. The system can integrate data feeds from an unlimited number of individual or clustered sensors, including any combination of, or all of, the following, and any future sensors that may be developed:
Location inputs, including Global positioning system (GPS);
Wind speed and direction,
Ambient temperature;
Humidity;
Barometric pressure;
Ultraviolet radiation exposure,
Ground slope angle and its orientation relative to the sun;
Vegetation moisture probes,
Vegetative density sensors;
Vegetation type identifiers;
Soil moisture probes;
High-Resolution Video feeds, updated per current technology developments;
Infrared (IR) cameras and sensors;
High-resolution still imagery cameras;
Acoustic sensors;
Gas analyzers, including any combination of, but not limited to: O2, O3, CO, CO2, NO, NO2, H2SO4, chlorine compounds, propane, methane, benzene, acrolein, polycyclic aromatic hydrocarbons (PAHs), volatile organic compounds (VOCs), hydrogen cyanide (HCN), sulfur dioxide (SO2), ammonia (NH3), particulate matter (PM2.5 and PM10) and other chemicals that may be present at, released, or diminished by wildfire activity.
Ground vibration monitors;
Thermal radiometers;
LIDAR systems;
HADAR systems;
Air quality monitors;
Radiation detectors;
Microwave radiometry;
Radar systems;
Soil composition sensors;
Electromagnetic field (EMF) sensors;
Satellite imagery;
Data input from specialized fire movement and behavior programs,
External POI maps;
Topographic data;
Lightning detection devices;
Doppler/Other RADAR;
Decibel Meter.

The system may employ:
Computer Vision Techniques: Capabilities spanning object detection, segmentation, and real-time video analytics, crucial for early fire detection and trend prediction.
Dynamic Data Processing: Rapid processing and real-time analytics of vast amounts of data from diverse sources to ensure up-to-the-moment insights.
Continuous Learning Mechanisms: AI/ML models that adapt and refine their predictive accuracies and strategic recommendations based on incoming data streams and previously integrated models.
Delineated Segments: Segments of the suppression plan are routed to quantum computing resources for analysis and processing, with their outputs then plugged back into the AI/ML module.

The system may solicit information about available local and national fire response resources as additional inputs. When used in communities where Computer-Aided Dispatch is used, the system can query these systems automatically to determine what equipment, personnel, and other resources are available. Some of the assets for which the disclosed system takes inventory follow and makes predictive allocation recommendations:
Heavy Equipment Assets:
   Quantity and type of Bulldozers;
   Quantity and type of Graders;
   Quantity and type of Backhoes
Aerial Resources:
   Quantity and type of winged aircraft (Fixed wing, spotters, VLATs, etc.);
   Quantity and type of rotary lift aircraft (Helicopters of various capabilities);
Vehicular Assets:
   Quantity and type of Type 1 Trucks;
   Quantity and type of Type 2 Trucks;
   Quantity and type of Type 3 Trucks;
   Quantity and type of Type 4 Trucks;
   Quantity and type of Type 5 Trucks;
   Quantity and type of Type 6 Trucks;
   Quantity and type of Pickup Trucks;
   Quantity and type of UTVs;
   Quantity and type of Water Tenders.
Marine Assets:
   Quantity and type of Type 1 Boats;
   Quantity and type of Type 2 Boats;
Personnel:
   Command Staff;
   Supervisory Staff,
   Firefighters;
   Hand Crews,
   Specialized Crew;
   Drone Operators;
   Communications Crew; and
   Public Information Officers.
Water Sources:
   Hydrants;
   Ocean,
   Rivers;
   Streams;
   Lakes;
   Ponds;
   Swimming Pools;
   Storage Tanks;
   Water Treatment Plants.
Hand Tools:
   Chainsaws;
   Rakes;
   Hoes;
   Axes;
   Drip Torches;
   Flappers.
Team Wildfire Assets:
   Hurricane;
   Cloud Burst;
   Storm Cell;
   Thunder Head.
UAV/UA S Assets:
   Drones;
   Unmanned helicopters.
Consumables:
   Suppressants,
   Retardants;
   Foams;
   Gels;
   Accelerants.
Support Services:
   Food;
   Lodging;
   Sanitation.
Logistical Factors and limiting factors.
   Distance between the fire and water sources;
   Means and availability for transporting water to the fire;
   Time to deliver water from source to destination;
   Calculation of gallons per minute that can be delivered to the fire combining the above data.

As discussed above, some or all of the above-listed available fire suppression assets may be prepopulated into an incident's data set by querying the dispatch software of nearby fire agencies (3rd-party sources) to determine which of that organization's assets are currently deployed elsewhere and which assets are available.

The system may take into account manufacturer's specifications of the capabilities and parameters for every vehicle (i.e., an XYZ truck can travel 60 mph on a zero slope, laden with a full tank, 30 mph on a 25-degree slope, and cannot climb steeper than a 60-degree slope. It can carry 2,000 gallons of water. It can operate on lateral surfaces of up to 20 degrees of slope. It can apply water over a distance of 200 feet from the truck. The fuel tank holds 150 gallons, which gives it an operational time of 16 hours between refills). This data may be used to help generate AI-based recommendations in the mathematical chess game against a fire.

The disclosed process according to some examples may eliminate the need for fire commanders to analyze the massive fire-related data using transcripts produced by the NPL processing. Instead, the equipment allocation and fire suppression recommendations may be produced directly on a granular level based on fire-associated digital data according to the AI-based predictive analysis and fire suppression recommendations.

This process includes a transparent recommendations/equipment allocation mechanism that may be coupled with a secure communications chat channel (implemented over a blockchain network) which supports all parties to set and agree on the deployment procedures and terms of administering assets to the fire site with each other. In some examples, the chat channel may be implemented using a chat Bot.

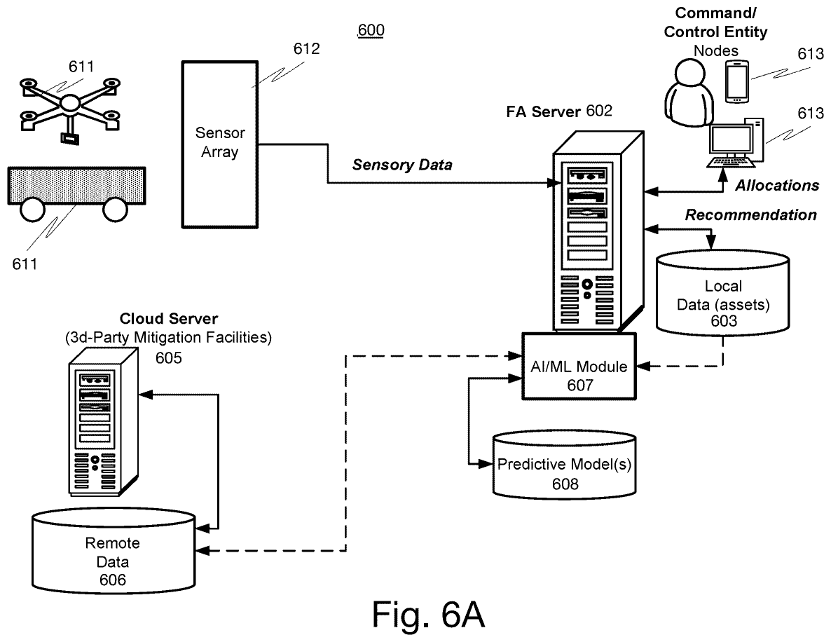

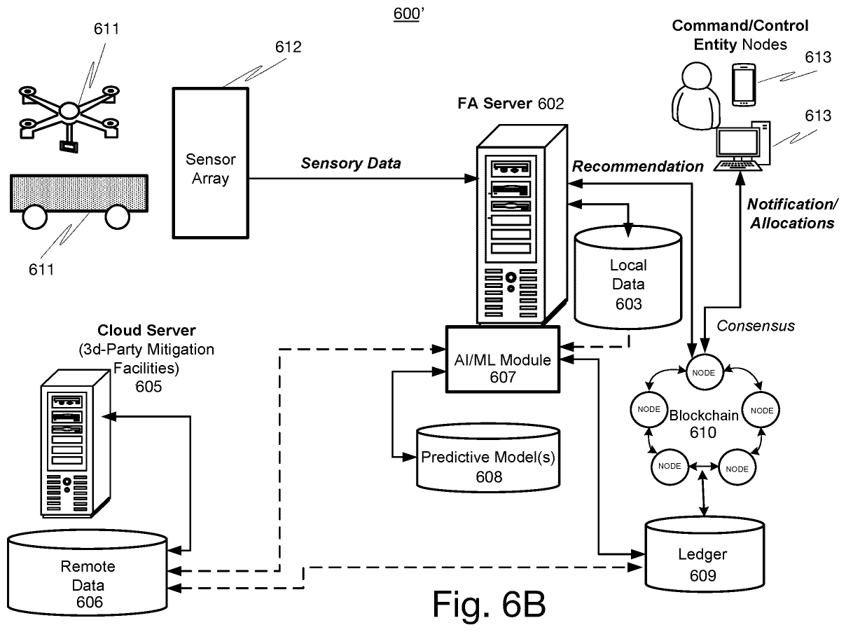

FIG. 6A illustrates a network diagram of a system for an AI-based automated real-time allocation of wildfire management and suppression equipment and assets based on predictive analytics of wildfire-related data consistent with the present disclosure.

Referring to FIG. 6A, the example network 600 includes the fire analysis server (FAS) node 602 connected to a cloud server node(s) 605 over a network. The FAS node 602 is configured to host an AI/ML module 607. The FAS node 602 may receive sensory data from an array of sensors 612 implemented on a fire surveillance device 611 (e.g., a drone or unmanned vehicle). The FAS node 602 may receive additional video/audio surveillance data from the fire surveillance device 611 implemented as a drone or an unmanned vehicle equipped with high-resolution video capturing devices.

The audio surveillance data may have language indicator metadata representing the language of the surveying personnel (or chatbot) transcribing the surveillance data. In some examples, the audio surveillance data may be processed by the FAS node 602 using the pre-trained large language models. The FAS node 602 may derive the language indicator and parse out the audio surveillance data based on the language indicator metadata. In other words, the key features of the audio surveillance data may be derived from the audio surveillance data based on the language of the surveyor.

In some examples, the language indicator may serve as a kind of a linguistic profile associated with the audio surveillance data. The language indicator may guide the A/ML module 607 in dynamically tailoring the processing methods. Depending on the language indicated, the FAS node 602 could engage specialized language models or apply unique natural language processing techniques optimized for that language.

Regarding the global reach of the disclosed system and method, a cultural intelligence layer may be added to the language indicator. The goal is for the system to not only recognize the language, but also adapt its recommendations and interactions to be culturally sensitive and appropriate. In some examples, the disclosed system may employ integrated translation capabilities. This may allow both the surveyor associated with the surveillance device 611 and a chatbot to communicate effortlessly, no matter where they are in the world or what languages they use. The language indicator may be used to trigger/initiate this feature, making the system truly globally effective.

The FAS node 602 may query a local fire suppression and equipment database for the historical local wildfires' data 603 associated with the current wildfire. The FAS node 602 may acquire relevant remote historical wildfires' suppression-related data 606 from a remote database residing on a cloud server 605. The remote historical wildfires' suppression-related data 606 may be collected from other wildfire sites and suppression command and control facilities. The remote historical wildfires' suppression-related data 606 may be collected from the fire sites of the same (or similar) ambient condition(s), location, size, intensity, etc. as the local wildfires associated with the current wildfire-related data provided by the surveillance devices 611.

The FAS node 602 may generate a feature vector or classifier data based on the wildfire-related sensory data, available suppression assets (equipment and personnel) data, and the collected wildfires'-related data (i.e., pre-stored local data 603 and remote data 606 reflecting characteristics of previous wildfires and the assets used for suppression). The FAS node 602 may ingest the feature vector data into an AI/ML module 607. The A/ML module 607 may generate a predictive model(s) 608 based on the feature vector data to predict asset allocation parameters for automatically generating a deployment plan and fire suppression recommendations to be provided to the command-and-control entities 613 (e.g., unit commanders, equipment managers, etc.). The fire suppression plan and/or risk assessment parameters generated based on predictive outputs of the model(s) 608 may be further analyzed by the FAS node 602 prior to generation of the final mitigation/deployment plan. In some examples, the asset allocation parameters may be used for adjustment of the initial wildfire response based on current updated availability of the personnel and equipment. Once the asset allocation is determined, an allocations/notification may be sent to the command-and-control entities 613. Then the deployment plan may be approved by the command-and-control entities 613 based on the allocations and risk assessment.

FIG. 6B illustrates a network diagram of a system for an AI-based automated real-time allocation of wildfire management and suppression equipment based on predictive analytics of wildfire-related data implemented over a blockchain consistent with the present disclosure.

Referring to FIG. 6B, the example network 600′ includes the fire analysis server (FAS) node 602 connected to a cloud server node(s) 605 over a network. The FAS node 602 is configured to host an AI/ML module 607. The FAS node 602 may receive sensory data from an array of sensors 612 implemented on a fire surveillance device 611 (e.g., a drone or unmanned vehicle). The FAS node 602 may receive additional video/audio surveillance data from the fire surveillance device 611 implemented as a drone or an unmanned vehicle equipped with high-resolution video capturing devices.

The audio surveillance data may have language indicator metadata representing the language of the surveying personnel (or chatbot) transcribing the surveillance data. In some examples, the audio surveillance data may be processed by the FAS node 602 using the pre-trained large language models. The FAS node 602 may derive the language indicator and parse out the audio surveillance data based on the language indicator metadata. In other words, the key features of the audio surveillance data may be derived from the audio surveillance data based on the language of the surveyor.

In some examples, the language indicator may serve as a kind of a linguistic profile associated with the audio surveillance data. The language indicator may guide the A/ML module 607 in dynamically tailoring the processing methods. Depending on the language indicated, the FAS node 602 could engage specialized language models or apply unique natural language processing techniques optimized for that language.

In some examples, the disclosed system may employ integrated translation capabilities. This may allow both the surveyor associated with the surveillance device 611 and a chatbot to communicate effortlessly, no matter where they are in the world or what languages they use. The language indicator may be used to trigger/initiate this feature, making the system truly globally effective.

The FAS node 602 may query a local fire suppression and equipment database for the historical local wildfires' data 603 associated with the current wildfire. The FAS node 602 may acquire relevant remote historical wildfires' suppression-related data 606 from a remote database residing on a cloud server 605. The remote historical wildfires' suppression-related data 606 may be collected from other wildfire sites and suppression command and control facilities. The remote historical wildfires' suppression-related data 606 may be collected from the fire sites of the same (or similar) ambient condition(s), location, size, intensity, etc. as the local wildfires associated with the current wildfire-related data provided by the surveillance devices 611.

The FAS node 602 may generate a feature vector or classifier data based on the wildfire-related sensory data, available suppression assets (equipment and personnel) data, and the collected wildfires'-related data (i.e., pre-stored local data 603 and remote data 606). The FAS node 602 may ingest the feature vector data into an A/ML module 607. The AI/ML module 607 may generate a predictive model(s) 608 based on the feature vector data to predict asset allocation parameters for automatically generating a deployment plan and fire suppression recommendations to be provided to the command-and-control entities 613 (e.g., unit commanders, equipment managers, etc.). The fire suppression plan and/or risk assessment parameters generated based on predictive outputs of the model(s) 608 may be further analyzed by the FAS node 602 prior to generation of the final mitigation/deployment plan. In some examples, the asset allocation parameters may be used for adjustment of the initial wildfire response based on current updated availability of the personnel and equipment. Once the asset allocation is determined, an allocations/notification may be sent to the command-and-control entities 613. Then the deployment plan may be approved by the command-and-control entities 613 based on the allocations and risk assessment.

In some examples, the FAS node 602 may receive the predicted asset allocation parameters from a permissioned blockchain 610 ledger 609 based on a consensus from the command-and-control entity nodes 613 confirming, for example, equipment and personnel allocations, wildfire suppression plan, deployment schedule, and other conditions. Additionally, confidential historical wildfire suppression-related information and previous fires'-related asset allocation parameters may also be acquired from the permissioned blockchain 610. The newly acquired wildfire-related data with corresponding predicted asset allocation and deployment recommendation parameters data may be also recorded on the ledger 609 of the blockchain 610 so it can be used as training data for the predictive model(s) 608. In this implementation, the FAS node 602, the command-and-control entity nodes 613, and surveyors' entities (not shown) may serve as blockchain 610 peer nodes. In some examples, local wildfires' data 603 and remote data 606 may be duplicated on the blockchain ledger 609 for higher security of storage. Allocation of assets may be recorded on the blockchain 610 as transactions indicating asset ownership and/or assignment.

In some examples, allocation recommendations recorded to the blockchain include assignments of specific fluid projecting platforms 100 or vehicles 300, along with associated operating parameters such as gimbal orientation, misting rate, or route of travel. This enables auditable coordination between central AI planning and distributed hardware execution.

The AI/ML module 607 may generate a predictive model(s) 608 to predict the asset allocation and deployment recommendation parameters for the current wildfire site in response to the specific relevant pre-stored fires'-related data (including asset allocations data) acquired from the blockchain 610 ledger 609. This way, the current asset allocations and deployment parameters may be predicted based not only on the current wildfire-related sensory data and current asset availability data, but also based on the previously collected heuristics and wildfires'-related data associated with the given wildfire site data or current allocation parameters generated based on the sensory data and surveillance data. This way, the most optimal way of handling the wildfire, such as the best personnel and equipment, are selected for suppressing the wildfire for the most likely successful mitigation.

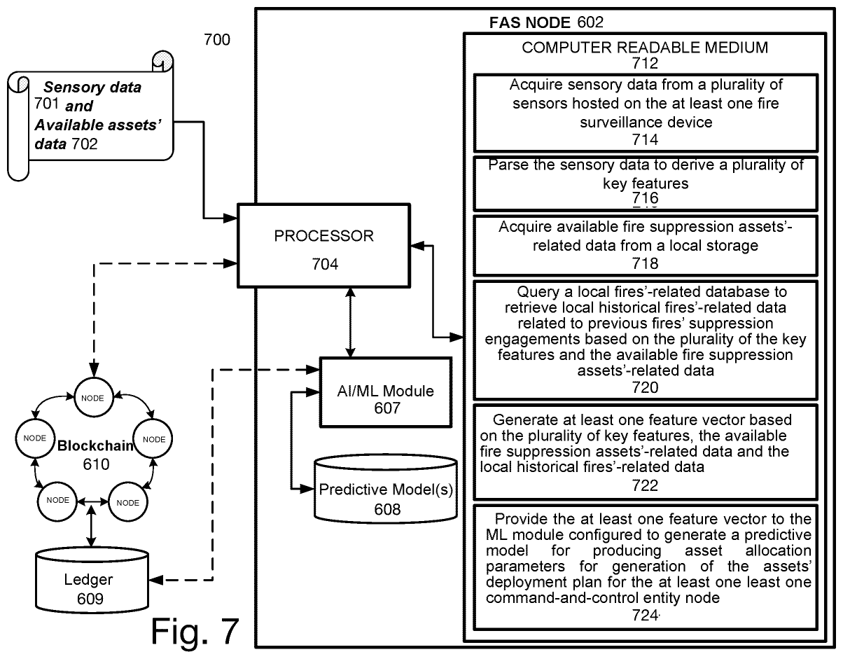

FIG. 7 illustrates a network diagram of a system including detailed features of a fire analysis server (FAS) node consistent with the present disclosure.

Referring to FIG. 7, the example network 700 includes the FAS node 602 connected to the sensor array 612 implemented on the surveillance devices 611 (see FIGS. 1A-1B) to receive the sensory data 701. The FAS node 602 is also connected to a local storage containing available assets' data 702.

The FAS node 602 is configured to host an AI/ML module 607. As discussed above with respect to FIGS. 1A-B, the FAS node 602 may receive the sensory data provided by the surveillance devices 611 (FIG. 6A) and pre-stored wildfires'-related data retrieved from local and remote databases. As discussed above, the wildfires'-related data may be optionally retrieved from the ledger 609 of the blockchain 610.

The AI/ML module 607 may generate a predictive model(s) 608 based on the received wildfire-related sensory data 701 and 702 and the surveillance'-related video/audio data provided by the FAS node 602. As discussed above, the AI/ML module 607 may provide predictive outputs data in the form of asset allocation parameters for automatic generation of deployment and suppression recommendations for the command-and-control entities 613 (see FIG. 6B). The FAS node 602 may process the predictive outputs data received from the AI/ML module 607 to generate the asset deployment plan and/or risk assessment recommendation pertaining to a particular wildfire suppression/mitigation engagement.

In some examples, the FAS node 602 may acquire and process current sensory data 201. In other examples, the FAS node 602 may continually monitor sensory data and may detect a parameter that deviates from a previous recorded parameter (or from a median reading value) by a margin that exceeds a threshold value preset for this particular parameter. For example, if a fire's intensity, spread, and movement rate change, this may cause a change in asset allocations or risk assessment. Accordingly, once the threshold is met or exceeded by at least one parameter of the wildfire, the FAS node 602 may provide the currently acquired fire-related sensory parameter to the AI/ML module 607 to generate an updated asset allocation or deployment recommendation parameters based on the current wildfire's conditions and updated risk assessment parameters.

While this example describes in detail only one FAS node 602, multiple such nodes may be connected to the network and to the blockchain 610. It should be understood that the FAS node 602 may include additional components and that some of the components described herein may be removed and/or modified without departing from a scope of the FAS node 602 disclosed herein. The FAS node 602 may be a computing device or a server computer, or the like, and may include a processor 704, which may be a semiconductor-based microprocessor, a central processing unit (CPU), an application specific integrated circuit (ASIC), a field-programmable gate array (FPGA), and/or another hardware device. Although a single processor 704 is depicted, it should be understood that the FAS node 602 may include multiple processors, multiple cores, or the like, without departing from the scope of the FAS node 602 system.

The FAS node 602 may also include a non-transitory computer readable medium 712 that may have stored thereon machine-readable instructions executable by the processor 704. Examples of the machine-readable instructions are shown as 714-724 and are further discussed below. Examples of the non-transitory computer readable medium 712 may include an electronic, magnetic, optical, or other physical storage device that contains or stores executable instructions. For example, the non-transitory computer readable medium 712 may be a Random-Access memory (RAM), an Electrically Erasable Programmable Read-Only Memory (EEPROM), a hard disk, an optical disc, or other type of storage device.

The processor 704 may fetch, decode, and execute the machine-readable instructions 714 to acquire sensory data from a plurality of sensors hosted on the at least one fire surveillance device. The processor 704 may fetch, decode, and execute the machine-readable instructions 716 to parse the sensory data to derive a plurality of key features. The processor 704 may fetch, decode, and execute the machine-readable instructions 718 to acquire available fire suppression assets'-related data from a local storage. The processor 704 may fetch, decode, and execute the machine-readable instructions 720 to query a local fires'-related database to retrieve local historical fires'-related data related to previous fires' suppression engagements based on the plurality of the key features and available fire suppression assets'-related data.

The processor 704 may fetch, decode, and execute the machine-readable instructions 722 to generate at least one feature vector based on the plurality of key features, the available fire suppression assets'-related data and the local historical fires'-related data. The processor 704 may fetch, decode, and execute the machine-readable instructions 724 to provide the at least one feature vector to the ML module configured to generate a predictive model for producing asset allocation parameters for generation of the assets' deployment plan for the at least one least one command-and-control entity node.

The permissioned blockchain 610 may be configured to use one or more smart contracts that manage transactions for multiple participating nodes and for recording the transactions on the ledger 609.

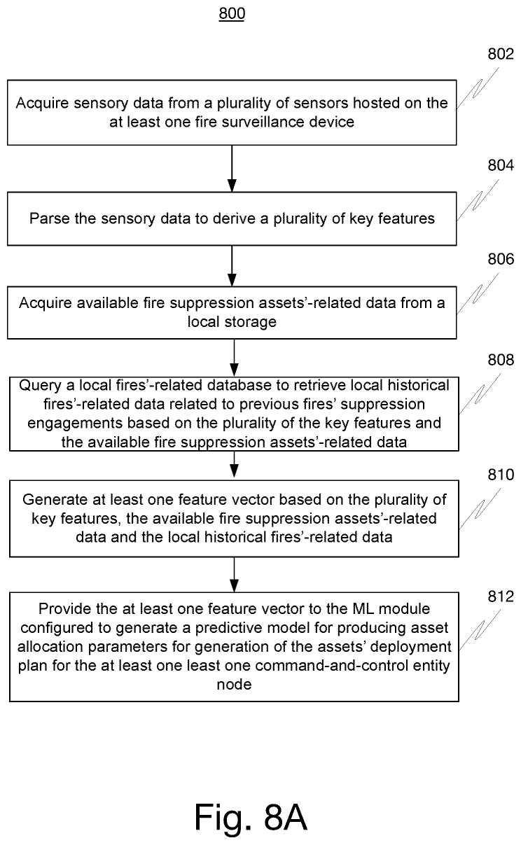

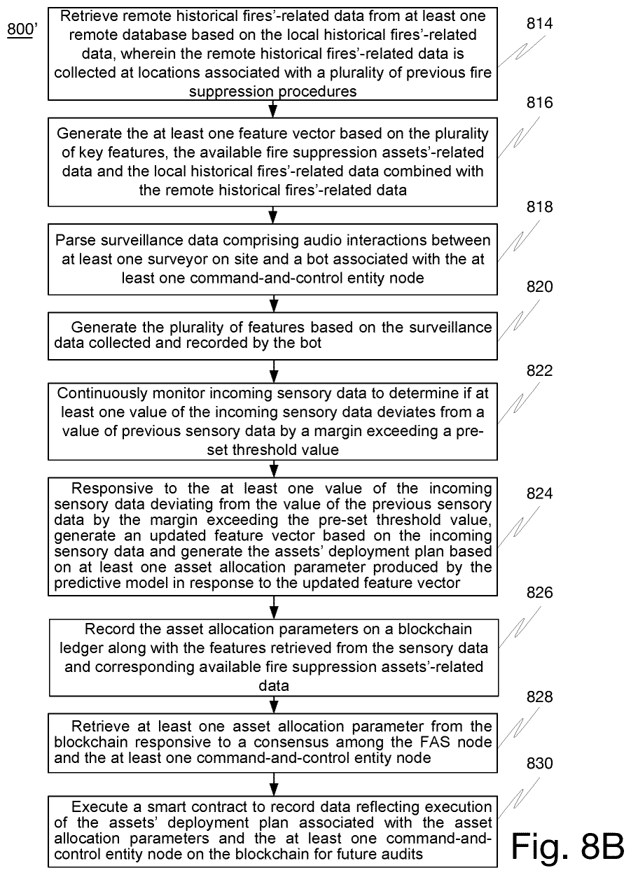

FIG. 8A illustrates a flowchart of a method for an AI-based automated real-time allocation of wildfire management and suppression equipment based on predictive analytics of wildfire-related data consistent with the present disclosure.

Referring to FIG. 8A, the method 800 may include one or more of the steps described below. FIG. 8A illustrates a flow chart of an example method executed by the FAS node 602 (see FIG. 7). It should be understood that method 800 depicted in FIG. 8A may include additional operations and that some of the operations described therein may be removed and/or modified without departing from the scope of the method 800. The description of the method 800 is also made with reference to the features depicted in FIG. 7 for purposes of illustration. Particularly, the processor 704 of the FAS node 602 may execute some or all of the operations included in the method 800.

With reference to FIG. 8A, at block 802, the processor 704 may acquire sensory data from a plurality of sensors hosted on the at least one fire surveillance device. At block 804, the processor 704 may parse the sensory data to derive a plurality of key features. At block 806, the processor 704 may acquire available fire suppression assets'-related data from a local storage. At block 808, the processor 704 may query a local fires'-related database to retrieve local historical fires'-related data related to previous fires' suppression engagements based on the plurality of the key features and available fire suppression assets'-related data. At block 810, the processor 704 may generate at least one feature vector based on the plurality of key features, the available fire suppression assets'-related data and the local historical fires'-related data. At block 812, the processor 704 may provide the at least one feature vector to the ML module configured to generate a predictive model for producing asset allocation parameters for generation of the assets' deployment plan for the at least one command-and-control entity node.

FIG. 8B illustrates a further flowchart of a method for AI-based automated real-time allocation of wildfire management and suppression equipment based on predictive analytics of wildfire-related data consistent with the present disclosure.

Referring to FIG. 8B, the method 800′ may include one or more of the steps described below.

FIG. 8B illustrates a flow chart of an example method executed by the FAS node 602 (see FIG. 7). It should be understood that method 800′ depicted in FIG. 8B may include additional operations and that some of the operations described therein may be removed and/or modified without departing from the scope of the method 800′. The description of the method 800′ is also made with reference to the features depicted in FIG. 7 for purposes of illustration. Particularly, the processor 704 of the FAS node 602 may execute some or all of the operations included in the method 800′.

With reference to FIG. 8B, at block 814, the processor 704 may retrieve remote historical fires'-related data from at least one remote database based on the local historical fires'-related data, wherein the remote historical fires'-related data is collected at locations associated with a plurality of previous fire suppression procedures. At block 816, the processor 704 may generate at least one feature vector based on the plurality of key features, the available fire suppression assets'-related data, and the local historical fires'-related data combined with the remote historical fires'-related data. At block 818, the processor 704 may parse surveillance data comprising audio interactions between at least one surveyor on site and a bot associated with the at least one command-and-control entity node. At block 820, the processor 704 may generate the plurality of features based on the surveillance data collected and recorded by the bot.

At block 822, the processor 704 may continuously monitor incoming sensory data to determine if at least one value of the incoming sensory data deviates from a value of previous sensory data by a margin exceeding a preset threshold value. At block 824, the processor 704 may, responsive to the at least one value of the incoming sensory data deviating from the value of the previous sensory data by the margin exceeding the preset threshold value, generate an updated feature vector based on the incoming sensory data and generate the assets' deployment plan based on at least one asset allocation parameter produced by the predictive model in response to the updated feature vector. At block 826, the processor 704 may record the asset allocation parameters on a blockchain ledger along with the features retrieved from the sensory data and corresponding available fire suppression assets'-related data. At block 828, the processor 704 may retrieve at least one asset allocation parameter from the blockchain responsive to a consensus among the FAS node and the at least one command-and-control entity node. At block 830, the processor 704 may execute a smart contract to record data reflecting execution of the assets' deployment plan associated with the asset allocation parameters and the at least one command-and-control entity node on the blockchain for future audits.

In some examples, the assets' allocation parameters' model may be generated by the AI/ML module 607 that may use training data sets to improve accuracy of the prediction of the assets' allocation parameters for the command-and-control entities 613 (FIGS. 1A-1B). The assets' allocation parameters used in training data sets may be stored in a centralized local database (such as one used for storing local fires' data 603 depicted in FIG. 6A). In some examples, a neural network may be used in the AI/ML module 607 for assets' allocation parameters modeling and deployment predictions.

In other examples, the AI/ML module 607 may use a decentralized storage such as a blockchain 610 (see FIG. 6B) that is a distributed storage system, which includes multiple nodes that communicate with each other. The decentralized storage includes an append-only immutable data structure resembling a distributed ledger capable of maintaining records between mutually untrusted parties. The untrusted parties are referred to herein as peers or peer nodes. Each peer maintains a copy of the parameter(s) records, and no single peer can modify the records without a consensus being reached among the distributed peers. For example, the peers 613 and 602 (FIG. 6B) may execute a consensus protocol to validate blockchain 610 storage transactions, group the storage transactions into blocks, and build a hash chain over the blocks. This process forms the ledger 609 by ordering the storage transactions, as is necessary, for consistency. In some examples, a permissioned and/or a permissionless blockchain can be used. In a public or permissionless blockchain, anyone can participate without a specific identity. Public blockchains can involve assets and use consensus based on various protocols such as Proof of Work (PoW). On the other hand, a permissioned blockchain provides secure interactions among a group of entities which share a common goal such as asset allocation parameters for efficient suppression of wildfires, but which do not fully trust one another.

This application utilizes a permissioned (private) blockchain that operates arbitrary, programmable logic, tailored to a decentralized storage scheme and referred to as “smart contracts” or “chaincodes.” In some cases, specialized chaincodes may exist for management functions and parameters which are referred to as system chaincodes. The application can further utilize smart contracts that are trusted distributed applications which leverage tamper-proof properties of the blockchain database and an underlying agreement between nodes, which is referred to as an endorsement or endorsement policy. Blockchain transactions associated with this application can be “endorsed” before being committed to the blockchain, while transactions which are not endorsed are disregarded. An endorsement policy allows chaincodes to specify endorsers for a transaction in the form of a set of peer nodes that are necessary for endorsement. When a client sends the transaction to the peers specified in the endorsement policy, the transaction is executed to validate the transaction. After a validation, the transactions enter an ordering phase in which a consensus protocol is used to produce an ordered sequence of endorsed transactions grouped into blocks.

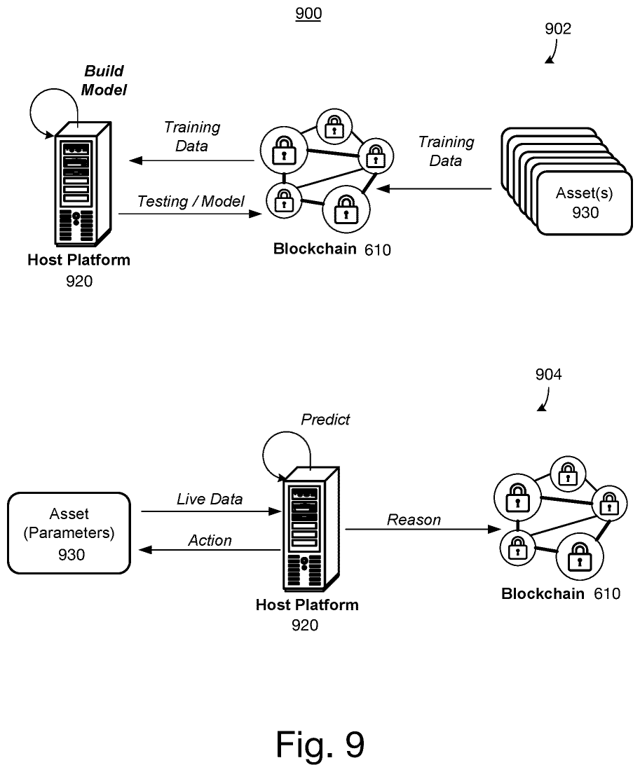

In the example depicted in FIG. 9, a host platform 920 (such as the FAS node 602) builds and deploys a machine learning model for predictive monitoring of assets 930. Here, the host platform 920 may be a cloud platform, an industrial server, a web server, a personal computer, a user device, and the like. Assets 930 can represent equipment and personnel allocation parameters as well as the actual fire suppression assets. The blockchain 610 can be used to significantly improve both a training process 902 of the machine learning model and the assets' allocation parameters' predictive process 904 based on a trained machine learning model. For example, in 902, rather than requiring a data scientist/engineer or other user to collect the data, historical data (heuristics—i.e., wildfires'-related data) may be stored by the assets 930 themselves (or through an intermediary, not shown) on the blockchain 610.

This can significantly reduce the collection time needed by the host platform 920 when performing predictive model training. For example, using smart contracts, data can be directly and reliably transferred straight from its place of origin (e.g., from the FAS node 602 or from the databases 603 and 606 depicted in FIGS. 1A-1B) to the blockchain 610. By using the blockchain 610 to ensure the security and ownership of the collected data, smart contracts may directly send the data from the assets to the entities that use the data for building a machine learning model. This allows for sharing of data among the assets 930. The collected data may be stored in the blockchain 610 based on a consensus mechanism. The consensus mechanism pulls in (permissioned nodes) to ensure that the data being recorded is verified and accurate. The data recorded is time-stamped, cryptographically signed, and immutable. It is therefore auditable, transparent, and secure.

Furthermore, training of the machine learning model on the collected data may take rounds of refinement and testing by the host platform 920. Each round may be based on additional data or data that was not previously considered to help expand the knowledge of the machine learning model. In 902, the different training and testing steps (and the data associated therewith) may be stored on the blockchain 610 by the host platform 920. Each refinement of the machine learning model (e.g., changes in variables, weights, etc.) may be stored on the blockchain 610. This provides verifiable proof of how the model was trained and what data was used to train the model. Furthermore, when the host platform 920 has achieved a finally trained model, the resulting model itself may be stored on the blockchain 610.

After the model has been trained, it may be deployed to a live environment where it can make recommendation-related predictions/decisions based on the execution of the final trained machine learning model using the prediction parameters. In this example, data fed back from the asset 930 may be input into the machine learning model and may be used to make event predictions such as most optimal asset allocation and deployment parameters for setting the wildfire suppression plans. Determinations made by the execution of the machine learning model (e.g., assets' allocation and deployment recommendations, risk assessment data, etc.) at the host platform 920 may be stored on the blockchain 610 to provide auditable/verifiable proof. As one non-limiting example, the machine learning model may predict a future change of a part of the asset 930 (the assets' allocation recommendation parameters—i.e., assessment of risk of unsuccessful fire suppression efforts). The data behind this decision may be stored by the host platform 920 on the blockchain 610.

### Example Computer System

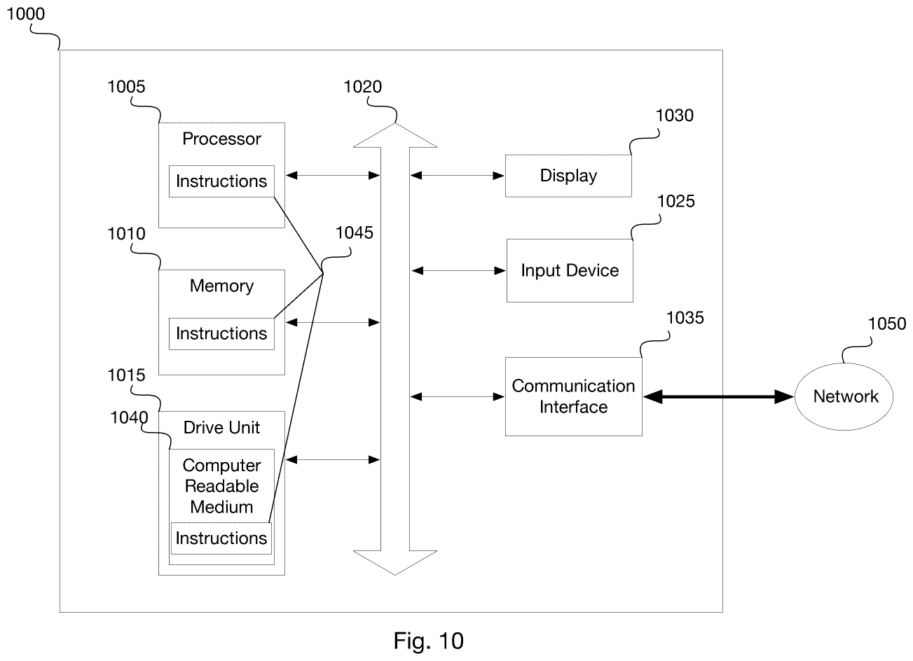

FIG. 10 illustrates an example of a computer system 1000 that can form part of or implement computational aspects of any of the systems and/or devices described above. The computer system 1000 can include a set of instructions 1045 that the processor 1005 can execute to cause the computer system 1000 to perform any of the operations described above. An example of the computer system 1000 can operate as a stand-alone device or can be connected, e.g., using a network, to other computer systems or peripheral devices.

In a networked example, the computer system 1000 can operate in the capacity of a server or as a client computer in a server-client network environment, or as a peer computer system in a peer-to-peer (or distributed) environment. The computer system 1000 can also be implemented or incorporated into various devices, such as a personal computer or a mobile device, capable of executing instructions 1045 (sequential or otherwise), causing a device to perform one or more actions. Further, each of the systems described can include a collection of subsystems that individually or jointly execute a set, or multiple sets, of instructions to perform one or more computer operations.

The computer system 1000 can include one or more memory devices 1010 communicatively coupled to a bus 1020 for communicating information. In addition, code operable to cause the computer system to perform operations described above can be stored in the memory 1010. The memory 1010 can be random-access memory, read-only memory, programmable memory, or any other type of memory or storage device.

The computer system 1000 can include a display 1030, such as a liquid crystal display (LCD), organic light-emitting diode (OLED) display, or any other display suitable for conveying information. The display 1030 can act as an interface for the user to see processing results produced by processor 1005.

Additionally, the computer system 1000 can include an input device 1025, such as a keyboard, mouse, or touchscreen, configured to allow a user to interact with components of system 1000.

The computer system 1000 can also include a non-volatile memory (NVM) controller 1015. The NVM controller 1015 can include a computer-readable medium 1040 (e.g., flash drive) in which the instructions 1045 can be stored. The instructions 1045 can reside completely, or at least partially, within the memory 1010 and/or within the processor 1005 during execution by the computer system 1000. The memory 1010 and the processor 1005 also can include computer-readable media, as discussed above.

The computer system 1000 can include a communication interface 1035 to support communications via a network 1050. The network 1050 can include wired networks, wireless networks, or combinations thereof. The communication interface 1035 can enable communications via any number of wireless broadband communication standards.

Accordingly, methods and systems described herein can be realized in hardware, software, or a combination of hardware and software. The methods and systems can be realized in a centralized fashion in at least one computer system or in a distributed fashion where different elements are spread across interconnected computer systems. Any kind of computer system or other apparatus adapted for carrying out the methods described herein can be employed.

The methods and systems described herein can also be embedded in a computer program product, which includes all the features enabling the implementation of the operations described herein and which, when loaded in a computer system, can carry out these operations. Computer program as used herein refers to an expression, in a machine-executable language, code, or notation, of a set of machine-executable instructions intended to cause a device to perform a particular function, either directly or after one or more of a) conversion of a first language, code, or notation to another language, code, or notation; and b) reproduction of a first language, code, or notation.

### ADDITIONAL EXAMPLES

Additional examples are disclosed in the clauses described below. It is understood that the examples set forth in the clauses can be combined with the examples described herein.

Clause 1. An ultrasonic humidification system for fire suppression comprising: a water reservoir; one or more ultrasonic transducer heads disposed within the water reservoir and configured to generate mist by atomizing water through high-frequency mechanical vibrations; a misting chamber configured to direct mist generated by the one or more ultrasonic transducer heads toward a mist output port; and a venturi interface configured to fluidically couple the mist output port to a high-velocity airflow source, wherein the venturi interface is configured such that high-velocity airflow from the high-velocity airflow source creates a vacuum that draws mist from the misting chamber into the airflow stream for fire suppression applications.

Clause 2. The ultrasonic humidification system of clause 1, wherein the water reservoir comprises a water level control apparatus configured to maintain water at a predetermined depth above the one or more ultrasonic transducer heads.

Clause 3. The ultrasonic humidification system of clause 2, wherein the water level control system comprises a float valve configured to maintain approximately two inches of water depth.

Clause 4. The ultrasonic humidification system of clause 1, further comprising one or more ultrasonic transducer modules, wherein each ultrasonic transducer module comprises one or more ultrasonic transducer heads and wherein each ultrasonic transducer module is powered by its own dedicated power supply module.

Clause 5. The ultrasonic humidification system of clause 4, wherein each ultrasonic transducer module comprises twelve ultrasonic transducer heads.

Clause 6. The ultrasonic humidification system of clause 1, wherein the misting chamber comprises one or more fans configured to create airflow through the misting chamber.

Clause 7. The ultrasonic humidification system of clause 1, wherein the ultrasonic humidification system is housed in a waterproof enclosure configured for mounting on a vehicle.

Clause 8. The ultrasonic humidification system of clause 1, wherein the high-velocity airflow source comprises a jet engine, wherein the venturi interface comprises a Y-connector positioned in an exhaust stream of the jet engine and a hose fluidically connecting the mist output port to the Y-connector.

Clause 9. The ultrasonic humidification system of clause 1, wherein the ultrasonic humidification system is configured for integration with a jet engine producing approximately 100 pounds of thrust.

Clause 10. The ultrasonic humidification system of clause 1, further comprising a mist/droplet screen positioned between the water reservoir and the misting chamber configured to retain non-aerosolized water droplets while allowing mist to pass to the misting chamber.

Clause 11. The ultrasonic humidification system of clause 1, wherein the high-velocity airflow source comprises a fan.

Clause 12. A fire suppression system comprising: a platform; a water conversion apparatus mounted on the platform and configured to convert water into airborne moisture, including at least one of: mist, steam, bubbles, or humidified air; and a delivery mechanism mounted on the platform and configured to distribute the converted water toward a fire suppression target.

Clause 13. The fire suppression system of clause 12, wherein the water conversion apparatus comprises one or more: ultrasonic transducers, steam generators, bubble generation systems, evaporation systems, high-pressure air fracking systems, nebulization systems, or any combination thereof.

Clause 14. The fire suppression system of clause 12, wherein the platform is a stationary platform positioned at a fixed location.

Clause 15. The fire suppression system of clause 12, wherein the platform is a mobile platform.

Clause 16. The fire suppression system of clause 12, wherein the platform corresponds to a pickup truck, a fire truck, an all-terrain vehicle (ATV), a marine vessel, an aircraft, or a railway car.

Clause 17. The fire suppression system of clause 12, wherein the delivery mechanism comprises a high-velocity airflow source configured to transport the converted water to the fire suppression target.

Clause 18. The fire suppression system of clause 16, wherein the high-velocity airflow source comprises one or more: jet engines, axial fans, centrifugal fans, blowers, turbofan engines, or any combination thereof.

### CONCLUSION

While the systems and methods of operation have been described with reference to certain examples, it will be understood by those skilled in the art that various changes can be made and equivalents can be substituted without departing from the scope of the claims. Therefore, it is intended that the present methods and systems not be limited to the particular examples disclosed, but that the disclosed methods and systems include all embodiments falling within the scope of the appended claims.

1. A fire suppression system comprising:
one or more fluid storage vessels;
one or more pumps fluidically coupled to the one or more fluid storage vessels;
one or more nozzles fluidically coupled to receive one or more fluids from the one or more pumps;
a jet engine configured to disperse the one or more fluids dispersed from the one or more nozzles; and
a platform configured to support the one or more fluid storage vessels, the one or more pumps, the one or more nozzles, and the jet engine, wherein the platform is configured to be mounted on a mobile chassis.

2. The fire suppression system of claim 1, wherein the mobile chassis is one of: a fire truck, a logging truck, a tracked vehicle, an emergency vehicle, an all-terrain vehicle, a trailer, a forwarder, or a skidder.

3. The fire suppression system of claim 1, wherein the platform comprises pre-drilled mounting points positioned to align with corresponding attachment points on the mobile chassis.

4. The fire suppression system of claim 1, wherein the platform is configured as a skid that facilitates use of a forklift to place the fire suppression system on the mobile chassis.

5. The fire suppression system of claim 1, wherein the platform comprises one or more coupling elements configured to facilitate lifting of the platform on to the mobile chassis.

6. The fire suppression system of claim 1, wherein the jet engine is configured to emit a jet-stream of gas in a direction non-coincident with an output direction of at least one of the one or more nozzles.

7. The fire suppression system of claim 1, further comprising a gimbal arm having a first end coupled to the platform and a second end coupled to the jet engine, wherein the gimbal arm is configured to facilitate pivoting and rotating of the jet engine.

8. The fire suppression system of claim 7, further comprising a controller configured to control the gimbal arm to direct the jet engine toward target locations.

9. The fire suppression system of claim 8, wherein the controller is configured to receive remote control commands from an operator and control the gimbal arm based on the remote control commands.

10. The fire suppression system of claim 8, further comprising one or more sensors configured to provide environmental data to the controller, wherein the controller comprises machine learning logic trained to process the sensor inputs and direct the gimbal arm to control jet engine orientation for fire suppression operations.

11. The fire suppression system of claim 1, wherein the platform is formed from one or more of:
steel, concrete, plastic, or an alloy.

12. The fire suppression system of claim 1, further comprising:
one or more ultrasonic humidification systems comprising:
a water reservoir;
one or more ultrasonic transducer heads disposed within the water reservoir and configured to generate mist by atomizing water through high-frequency mechanical vibrations;
a misting chamber configured to direct mist generated by the one or more ultrasonic transducer heads toward a mist output port; and
a venturi interface configured to fluidically couple the mist output port to the jet engine, wherein the venturi interface is configured such that high-velocity airflow from the jet engine creates a vacuum that draws mist from the misting chamber into the airflow stream.

13. The fire suppression system of claim 1, wherein the one or more fluids comprise one or more water, foams, retardants, thermal barrier gels, chemical modifiers, dispersants, oxygen scavengers, agricultural sprays, corrosion inhibitors, bio-agents or any combination thereof.

14. A fire suppression vehicle comprising:
one or more fluid storage vessels mounted on a chassis of the vehicle;
one or more pumps mounted on a chassis of the vehicle and fluidically coupled to the one or more fluid storage vessels;
one or more nozzles fluidically coupled to receive one or more fluids from the one or more pumps;
a jet engine mounted on a chassis of the vehicle and configured to disperse the one or more fluids dispersed from the one or more nozzles; and
a controller configured to control vehicle movement and fire suppression operations, wherein the controller is configured to receive instructions that cause the vehicle to drive to one or more locations and deploy the fire suppression system.

15. The fire suppression vehicle of claim 14, further comprising a gimbal arm having a first end coupled to the chassis and a second end coupled to the jet engine, wherein the gimbal arm is configured to facilitate pivoting and rotating of the jet engine.

16. The fire suppression vehicle of claim 15, wherein the controller is configured to control the gimbal arm to direct the jet engine toward target fire locations.

17. The fire suppression vehicle of claim 16, wherein the controller comprises machine learning logic trained to autonomously control the gimbal arm based on fire conditions detected by sensors.

18. The fire suppression vehicle of claim 17, further comprising sensors configured to provide environmental data to the controller, wherein the machine learning logic is trained to process the sensor inputs and determine optimal gimbal positioning for fire suppression operations.

19. The fire suppression vehicle of claim 14, wherein the controller is configured to receive instructions from an external artificial-intelligence-enabled command and control system and control vehicle operations based on the received instructions.

20. The fire suppression vehicle of claim 14, further comprising a wireless communication system configured to facilitate bidirectional exchange of control commands and sensor data with a remote operator or command center.

21. The fire suppression vehicle of claim 18, wherein the machine learning algorithms comprise convolutional neural networks configured to analyze infrared sensor streams to identify hotspots and reinforcement learning models configured to adjust gimbal orientation in real time.

22. An ultrasonic humidification system for fire suppression comprising:
a water reservoir;
a plurality of ultrasonic transducer heads disposed within the water reservoir and configured to generate mist by atomizing water through high-frequency mechanical vibrations;
a misting chamber configured to direct mist generated by the plurality of ultrasonic transducer heads toward a mist output port; and
a venturi interface configured to fluidically couple the mist output port to a high-velocity airflow source, wherein the venturi interface is configured such that airflow from the high-velocity airflow source creates a vacuum that draws mist from the misting chamber into the airflow stream for fire suppression applications.

23. The ultrasonic humidification system of claim 22, wherein the water reservoir comprises a water level control apparatus configured to maintain water at a predetermined depth above the plurality of ultrasonic transducer heads.

24. The ultrasonic humidification system of claim 23, wherein the water level control system comprises a float valve configured to maintain approximately two inches of water depth.

25. The ultrasonic humidification system of claim 22, further comprising one or more ultrasonic transducer modules, wherein each ultrasonic transducer modules comprises one or more ultrasonic transducer heads and wherein each ultrasonic transducer module is powered by its own dedicated power supply module.

26. The ultrasonic humidification system of claim 25, wherein each ultrasonic transducer modules comprises twelve ultrasonic transducer heads.

27. The ultrasonic humidification system of claim 22, wherein the misting chamber comprises one or more fans configured to create airflow through the misting chamber.

28. The ultrasonic humidification system of claim 22, wherein the ultrasonic humidification system is housed in a waterproof enclosure configured for mounting on a vehicle.

29. The ultrasonic humidification system of claim 22, wherein the high-velocity airflow source comprises a jet engine, wherein the venturi interface comprises a Y-connector positioned in an exhaust stream of the jet engine and a hose fluidically connecting the mist output port to the Y-connector.

30. The ultrasonic humidification system of claim 22, wherein the ultrasonic humidification system is configured for integration with a jet engine producing approximately 100 pounds of thrust.

31. The ultrasonic humidification system of claim 22, further comprising a mist/droplet screen positioned between the water reservoir and the misting chamber configured to retain non-aerosolized water droplets while allowing mist to pass to the misting chamber.

32. The ultrasonic humidification system of claim 22, wherein the high-velocity airflow source comprises a fan.
